(19) United States
(12) Patent Application Publication
(10) Pub. No.: US 2019/0166338 A1
(43) Pub. Date: May 30, 2019

(54) PROJECTION APPARATUS

(71) Applicant: JAGUAR LAND ROVER LIMITED, Conventry (GB)

(72) Inventor: JEREMY J. GREENWOOD, Warwickshire (GB)

(21) Appl. No.: 16/183,355

(22) Filed: Nov. 7, 2018

(30) Foreign Application Priority Data
Nov. 28, 2017 (GB) 1719704.7

(51) Int. Cl. H04N 9/31; G06K 9/00; G08G 1/14; B60R 1/00

(52) U.S. Cl. CPC H04N 9/3185; H04N 9/3155; G03B 21/2033; G08G 1/142; B60R 1/00; G06K 9/00791

(57) ABSTRACT

A projection system for projecting an indicator to provide a visible representation of at least a portion of a target route can include a light source operable to emit light and image forming means for forming the indicator. The projection system can include a processor for controlling the image forming means. The processor can be configured to determine a target route and, based on the determined target route, to control the image forming means to control the light emitted from the light source to form the indicator.

### CROSS REFERENCE TO RELATED APPLICATION

This application claims priority to and the benefit of GB Patent Application No. 1719704.7 filed Nov. 28, 2017, which is incorporated by reference herein in its entirety.

### TECHNICAL FIELD

The present disclosure relates to a projection apparatus. More particularly, but not exclusively, the present disclosure relates to a projection apparatus for a parking beacon or a vehicle.

### BACKGROUND

It is known to provide vehicle parking systems for parking a trailer coupled to a vehicle. A target route may be generated to guide the trailer to a selected parking location. A vehicle control signal is output to control the vehicle, thereby guiding the trailer to the parking location. A potential shortcoming of known systems are the challenges associated in identifying a suitable parking location as the user may have limited information to assess factors such as surface condition or gradient.

At least in certain embodiments, the present invention seeks to ameliorate or overcome at least some of the aforementioned problems.

### SUMMARY

Aspects of the present invention relate to a projection apparatus; a parking beacon; a vehicle; and a parking assist controller as claimed in the appended claims.

According to a further aspect of the present invention there is provided a projection system for projecting an indicator to provide a visible representation of at least a portion of a target route, the projection system comprising:

a light source operable to emit light;

image forming means for forming the indicator; and

a processor for controlling the image) forming means;

wherein the processor is configured to determine a target route; and, in dependence on the determined target route, to control the image forming means to control the light emitted from the light source to form the indicator. The projection system is an optical projection system. In use, the indicator may be projected onto a surface, such as the ground. The indicator provides a visible representation of the target route. The visible representation of the target route may enable an individual to predict the path that the vehicle is taking.

The indicator may comprise a direction marker and/or a path line for representing the target route. The image forming means may be operable to project the indicator onto the ground. The target route may be generated from a current position to a target position.

The projection system may be selectively activated and deactivated. The projection system may, for example, project the indicator when the vehicle is reversing or when the vehicle is performing a parking manoeuvre. The operation of the projection system may be inhibited outside of these operational scenarios. However, the present invention is not limited in this respect and the projection system could be used in other operational scenarios.

The projection of the indicator could be used to facilitate the remote control of a vehicle, for example to perform a parking manoeuvre. A user controlling the vehicle is provided with a visible representation of the vehicle trajectory and, at least in certain embodiments, this may help the user to visualise the vehicle movements. For example, the projection of the indicator may enable the user to identify potential collisions and pre-emptively to take the necessary action to avoid the collision. The projection of the indicator may also be useful for a driver of the vehicle, for example to assess clearance between the vehicle and an obstacle.

In use, the indicator may be projected onto a surface, such as the ground.

The indicator may comprise a graphical symbol or indicia representing the target route. For example, the indicator may comprise one or more arrows to represent the vehicle trajectory. Alternatively, or in addition, the indicator may comprise one or more path lines to represent the target route. The indicator may comprise a representation of the sides of the vehicle, for example representing a maximum width of the vehicle.

The image forming means may comprise optical guide means for defining a light path for light emitted from said light source. The optical guide means may be movable to control the direction of the light path. The processor may be configured to control movement of the optical guide means to form the indicator.

The optical guide means may comprise a reflecting assembly. The reflecting assembly may comprise a movable mirror or a movable reflective prism.

The image forming means may comprise a light engine. The light engine may, for example, comprise a plurality of mirrors which may be controlled independently of each other. The processor may be configured to control the light engine to form an image corresponding to the indicator. The light engine may comprise an optical assembly to direct light emitted from the light source to form the indicator. The plurality of mirrors may be arranged to controllably reflect light from the light source.

The image forming means may comprise optical guide means for guiding light emitted from said light engine.

The projection system may comprise a self-levelling assembly for supporting the light source and the image forming means.

The projection system may comprise one or more of the light sources. The or each light source may comprise at least one light emitting diode (LED). The or each light source may comprise LEDs having the same colour or different colours, for example red green and blue (RGB) LEDs. Alternatively, the or each light source may comprise a laser diode.

The projection system may comprise a lens assembly for projecting the indicator.

The indicator may comprise a target route. The target route may represent a path from a current location of the vehicle to a target location.

The indicator may comprise an indication of a vehicle trajectory. The indicator may, for example, represent the vehicle trajectory of a host vehicle. The vehicle trajectory may, for example, be determined in dependence on a current steering angle.

The processor may be configured to calculate the target route. For example, the processor may plot the target route from a current location of the vehicle to a target location. Alternatively, or in addition, the processor may calculate the vehicle trajectory in dependence on a current steering angle.

The indicator may comprise a speed indicator component to provide an indication of the speed of the vehicle. By way of example, the colour of the indicator may change in dependence on a predicted speed of the vehicle.

According to a further aspect of the present invention there is provided a parking beacon comprising a projection system as described herein.

The parking beacon may comprise an imaging system for capturing an image of the indicator projected onto a surface. An imaging processor may be provided for comparing the captured image with a reference image of the projected indicator. The imaging processor may be configured to determine a characteristic of the surface in dependence on said comparison.

The surface may be a section of ground. The characteristic determined by the imaging processor may comprise a gradient or contour map of the section of ground.

According to a further aspect of the present invention there is provided a vehicle comprising a projection system as described herein.

The vehicle may comprise an imaging system for capturing an image of the indicator projected onto a surface. An imaging processor may be provided for comparing the captured image with a reference image of the projected indicator. The imaging processor may be configured to determine the characteristic of the surface in dependence on said comparison.

The surface may be a section of ground. The characteristic determined by the imaging processor may comprise a gradient or contour map of the section of ground.

The vehicle may comprise a guidance module for determining a target route for the vehicle. The guidance module may be configured to alter the target route in dependence on the determined characteristic(s) of the surface.

According to a still further aspect of the present invention there is provided a parking assist controller for parking a vehicle, the parking assist controller being configured to:

receive image data from one or more image sensors;

analyse the image data to identify an indicator projected by a projection system as described herein; and

determine a target route for the vehicle in dependence on the identified indicator.

The parking assist controller may be configured to generate a parking assist signal in dependence on the determined target route.

The projection system may comprise a part of a parking beacon and the parking assist controller comprises a part of the vehicle.

The projection system may comprise a part of the vehicle. The parking assist controller may comprise a part of a parking beacon.

According to a still further aspect of the present invention there is provided a method of generating a visible representation of at least a portion of a target route, the method comprising:

determining a target route from a current position to a target position;

forming an image comprising an indicator, the indicator being formed in dependence on the target route; and

projecting the image onto a surface. The image may, for example, be projected onto the ground.

According to a further aspect of the present invention there is provided a route analysis system for a vehicle, the route analysis system comprising a processor configured to:

determine a target route for the vehicle;

generate a target route indicator for projection onto a section of ground to provide a visual representation of the determined target route;

receive image data from one or more image sensors, the image data comprising an image of a section of ground onto which the target route indicator is projected;

process the image data to identify an incident route indicator generated by the projection of the route indicator;

identify distortions in the incident route indicator caused by projecting the route indicator onto the section of ground; and

identify one or more terrain features in said section of ground in dependence on the identified distortions. The target route indicator is projected onto a section of ground, for example in a direction of travel of a vehicle. The shape and/or profile of the target route indicator may be predetermined in dependence on the target route. However, the projected target route indicator may be distorted by terrain features, for example surface roughness or an incline, on the section of ground onto which the route indicator is projected. Due to the presence of the terrain features, the incident route indicator captured by the image sensor(s) may comprise distortions. Thus, the incident route indicator may differ from the target route indicator projected onto the section of ground. By identifying and such distortions in the incident route indicator, the route analysis system may identify the terrain feature(s) along the target route of the vehicle. Image data comprising an image of that section of ground is collated and the incident route indicator identified.

It will be understood that the section of ground onto which the target route indicator is projected will change as the vehicle moves, thereby providing a rolling horizon. In use, the target route of the vehicle may be analysed continuously.

The profile of the incident route indicator is determined and any distortions identified. The distortions may correspond to differences between the predetermined reference pattern and the incident pattern identified in the image data. Each distortion may be indicative of a terrain feature which has altered the shape or profile of the target route indicator. By analysing the distortions, the processor may identify corresponding terrain features. When incorporated on a vehicle, the route analysis system allows the contours of the ground to be analysed, for example to identify changes in incline or gradient. The processor may be configured to control one or more vehicle systems in dependence on the identified terrain features, for example to control a torque output by a torque generating machine.

The target route indicator may be represented as an image. The image representing the target route indicator may be considered as a source image which is undistorted.

The processor may comprise an image processing module to analyse the image data and to identify the incident route indicator. For example, an image processor may identify the incident route indicator by applying a contrast filter or a colour filter to isolate the incident pattern. The image processing module may compare the incident route indicator with an image corresponding to the target route indicator to identify said distortions.

The identification of distortions in said incident pattern may comprise comparing the incident route indicator derived from the image data with the target route indicator. The target route indicator may comprise a projection of one or more predetermined shapes or patterns onto a surface having a known configuration. For example, the target route indicator may be projected onto a substantially flat surface which is at least substantially horizontal. Any distortions in the incident route indicator may represent terrain features which differ from the known surface configuration.

The processor may be configured to identify one or more of the following distortions: compression of the target route indicator, extension of the target route indicator; skewing of the target route indicator; discontinuities in the target route indicator.

The target route indicator may comprise one or more path lines representing the target route. The path lines could couple a interrupted line, for example in the form of a dashed line. Alternatively, the path lines may be at least substantially continuous. The projection of a substantially continuous path line may facilitate identification of terrain features along the length of the projected target route indicator. The one or more path lines may represent one or more of the following: a first path of a first wheel; a second path of a second wheel; and a centre path of a centerline of the vehicle. The first wheel may be disposed on a first side of the vehicle. The second first wheel may be disposed on a second side of the vehicle.

The target route indicator may comprise one or more arrows representing a vehicle trajectory.

The one or more terrain features may comprise one or more of the following: an incline; a depression; a mound; surface roughness; and an object.

The target route indicator may be encoded. The encoding of the predetermined reference pattern may, for example, comprise changing the intensity of light emitted to form the predetermined reference pattern. The encoding of the predetermined reference pattern may facilitate identification of the incident pattern. The identification of the incident route indicator may comprise identifying encoded image data.

The target route indicator may be generated by a projection system disposed in a beacon. The image may be captured by one or more image sensors disposed in a vehicle.

According to a further aspect of the present invention there is provided a vehicle comprising a route analysis system as described herein. The route analysis system may determine the target route in front of the vehicle, for example when the vehicle is travelling in a forward direction. Alternatively, or in addition, the route analysis system may determine the target route behind the vehicle, for example when the vehicle is reversing.

The beacon may comprise a projection system for projecting a target route indicator onto a section of ground.

The beacon may comprise one or more light sources for emitting light to generate the target route indicator. At least one of the one or more light sources may be configured to encode the target route indicator. The one or more light sources comprise a laser.

The beacon may comprise a controllable mirror for reflecting light emitted from said one or more light sources to generate said target route indicator.

The beacon may be portable. The projection system may be configured to project a parking location indicator.

According to a further aspect of the present invention there is provided a method of analysing a route for a vehicle, the method comprising:

determine a target route for the vehicle;

project a target route indicator onto a section of ground to provide a visual representation of the determined target route;

capturing an image of the section of ground onto which the target route indicator is projected;

analysing the image to identify an incident route indicator generated by the projection of the target route indicator onto the section of ground;

identifying distortions in said incident route indicator caused by projecting the target route indicator onto the section of ground; and

identifying one or more terrain features in said section of ground in dependence on the identified distortions.

The identification of the distortions in said incident route indicator may comprise comparing the incident route indicator derived from the image data with the target route indicator. The distortions may be identified by comparing the incident route indicator derived from the image data with the target route indicator generated in dependent on the target route.

The method may comprise identifying one or more of the following distortions: compression of the target route indicator, extension of the target route indicator; skewing of the target route indicator; discontinuities in the target route indicator.

The target route indicator may comprise one or more path lines representing the target route. The said one or more path lines represent one or more of the following: a first path of a first wheel; a second path of a second wheel; and a centre path of a centerline of the vehicle. The first wheel may be disposed on a first side of the vehicle. The second first wheel may be disposed on a second side of the vehicle.

The target route indicator comprises one or more arrows representing a vehicle trajectory.

The one or more terrain features may comprise one or more of the following: an incline; a depression; a mound; surface roughness; and an object.

The target route indicator may be generated by a projection system disposed in a beacon.

The image may be captured by one or more image sensors disposed in a vehicle.

According to a further aspect of the present invention there is provided a non-transitory computer-readable medium having a set of instructions stored therein which, when executed, cause a processor to perform the method described herein.

According to a further aspect of the present invention there is provided a terrain feature analysis system for use with a vehicle, the terrain feature analysis system comprising a processor configured to:

receive image data from one or more image sensors, the image data comprising an image of a section of ground onto which a predetermined reference pattern is projected;

process the image data to identify an incident pattern generated by the projection of the predetermined reference pattern onto the section of ground;

identify distortions in the incident pattern caused by projecting the predetermined reference pattern onto the section of ground; and
identify one or more terrain features in said section of ground in dependence on the identified distortions.

According to a further aspect of the present invention there is provided a method of analysing terrain features for use with a vehicle, the method comprising:

projecting a predetermined reference pattern onto a section of ground;

capturing an image of the section of ground onto which the predetermined reference pattern is projected;

analysing the image to identify an incident pattern generated by the projection of the predetermined reference pattern onto the section of ground;

identifying distortions in the incident pattern caused by projecting the predetermined reference pattern onto the section of ground; and

identifying one or more terrain features in said section of ground in dependence on the identified distortions.

It is to be understood that references herein to terrain features include one or more of the following set: incline; gradient (ascending or descending); dips; depressions; holes; drops; ruts; steps; rocks; surface roughness; (impassable) obstructions; and surface composition. In addition to identification of the terrain features, the method and apparatus described herein may grade the terrain features. The terrain features may be graded in dependence on one or more of the following set: size, severity and prevalence. The techniques described herein may also reference the type of terrain to be traversed. It will be understood that the term ‘type of terrain’ refers to the material comprised by the terrain, such as asphalt, grass, gravel, snow, mud, rock and/or sand. The type of terrain may optionally provide an indication of a coefficient of friction of the surface. The type of terrain may be determined using one or more sensor or may be specified by a user.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a park assist system in accordance with an embodiment of the present invention;

FIG. 2 shows a schematic representation of a vehicle incorporating a park assist controller for use in the park assist system shown in FIG. 1;

FIG. 3 shows a schematic representation of a parking beacon for use in the park assist system shown in FIG. 1;

FIG. 4A shows a block diagram representing operation of the parking assist system to project an encoded parking location indicator;

FIG. 4B shows a block diagram representing operation of the parking assist system to generate a target route;

FIG. 5 illustrates a target route generated by the park assist system for guiding a trailer to a target position;

FIG. 6A shows a display image from a rear camera with a graphical overlay representing the target position of the trailer;

FIG. 6B shows a birds-eye view image including features of the trailer to be projected along with the parking location indicator;

FIG. 7 shows a block diagram representing operation of the parking assist system to generate a graphical representation of the target route;

FIG. 8 illustrates the vehicle and trailer dimensions and associated nomenclature for determining the target route for the trailer;

FIG. 9 shows a schematic representation of a vehicle incorporating a park assist controller in accordance with a further embodiment of the present invention;

FIG. 10 illustrates a target route generated by the park assist system for guiding the host vehicle to a target position;

FIG. 11 shows a schematic representation of a vehicle incorporating a park assist controller in accordance with a further embodiment of the present invention;

FIG. 12 illustrates a target route generated by the park assist system for guiding a remote vehicle to the target position;

FIG. 13 shows a block diagram representing operation of the parking assist system to transmit a target route to the remote vehicle;

FIG. 14 shows a schematic representation of an alternative parking beacon for use in accordance with the present invention;

FIG. 15 illustrates a target route generated by the park assist system utilising the parking beacon illustrated in FIG. 12;

FIG. 16A illustrates the operation of the parking beacon shown in FIG. 12 to project a terrain reference pattern onto a flat surface;

FIG. 16B illustrates the operation of the parking beacon shown in FIG. 12 to project a terrain reference pattern onto an uneven surface;

FIG. 17 shows a block diagram representing operation of the parking assist system to analyse a projected reference pattern to identify terrain features;

FIG. 18 illustrates the operation of the parking beacon shown in FIG. 12 to project a terrain reference pattern between the target position and the current position of the towed vehicle;

FIG. 19 represents a torque profile required to propel the towed vehicle to the target position based on analysis of the terrain reference pattern;

FIG. 20 shows a block diagram representing operation of the parking assist system to generate a torque control strategy;

FIG. 21A illustrates the operation of the parking beacon shown in FIG. 12 to project a vehicle visible warning indicator onto a flat surface;

FIG. 21B illustrates the operation of the parking beacon shown in FIG. 12 to project a vehicle visible warning indicator onto an uneven surface;

FIG. 22A illustrates the operation of the parking beacon shown in FIG. 12 to project path lines onto a flat surface;

FIG. 22B illustrates the operation of the parking beacon shown in FIG. 12 to project path lines onto an uneven surface;

FIG. 23 shows a block diagram representing operation of the parking assist system to analyse a projected route indicator to identify terrain features;

FIG. 24 shows a schematic representation of a parking beacon incorporating a parking assist controller in accordance with an embodiment of the present invention;

FIG. 25 shows a schematic representation of an exemplary parking scenario utilising the parking beacon shown in FIG. 24;

FIG. 26 shows a schematic representation of a first augmented image generated by the parking beacon shown in FIG. 25;

FIG. 27 shows a schematic representation of a second augmented image generated by the parking beacon shown in FIG. 25;

FIG. 28 shows a schematic representation of a docking station for the parking beacon shown in FIG. 25; and

FIG. 29 shows a schematic representation of an exemplary parking scenario utilising a variant of the parking beacon shown in FIG. 24.

### DETAILED DESCRIPTION OF THE EMBODIMENTS

A parking assist system 1 in accordance with an aspect of the present invention will now be described with reference to the accompanying Figures. The parking assist system 1 according to the present embodiment is operative to assist maneuvering of a towing vehicle 2 and a towed vehicle 3 coupled together by an articulated coupling. The parking assist system 1 has particular application in assisting in the performance of a reversing manoeuvre, for example to perform a reverse parking manoeuvre to park the towed vehicle 3 (and optionally also the towing vehicle 2). The reverse parking manoeuvre may, for example, comprise parallel parking or tandem parking.

As described herein, the parking assist system 1 comprises a parking assist controller 4 and a parking beacon 5. The parking assist controller 4 in the present embodiment is installed in the towing vehicle 2. The towing vehicle 2 is illustrated herein as an automobile, such as a utility vehicle or a sports utility vehicle (SUV), but it will be understood that the parking assist system 1 described herein may be used in other vehicle types, such as a tractor. The towed vehicle 3 in the present embodiment comprises a trailer, such as a caravan. The parking beacon 5 in the present embodiment is a portable device which is adapted to be positioned externally of the towed vehicle 3 to indicate a target position for parking the towed vehicle 3.

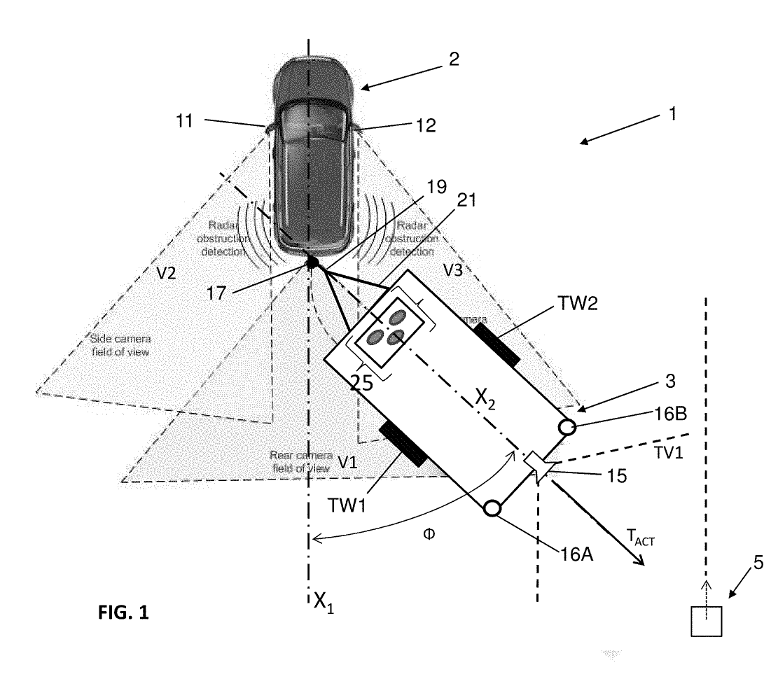

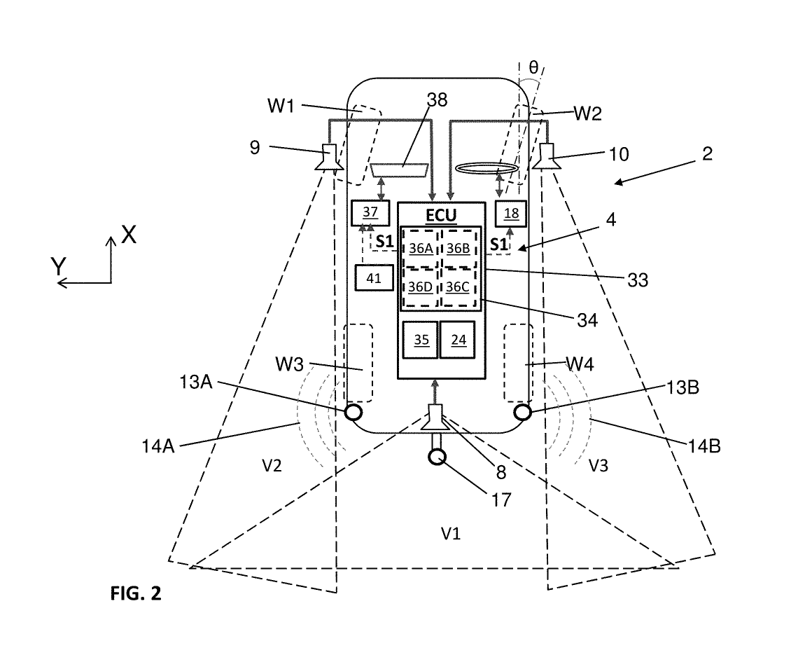

A plan view of the towing vehicle 2 and the towed vehicle 3 is shown in FIGS. 1 and 2. The towing vehicle 2 has a first longitudinal axis X1 and the towed vehicle 3 has a second longitudinal axis X2. As shown in FIG. 2, the towing vehicle 2 has two front wheels W1, W2 and two rear wheels W3, W4. As illustrated in FIG. 2, the front wheels W1, W2 of the towing vehicle 2 are steerable in conventional manner to define a steering angle θ. The steering angle θ is the orientation of the front wheels W1, W2 relative to the longitudinal axis X1 of the towing vehicle. The towed vehicle 3 in the present embodiment has two trailer wheels TW1, TW2. The trailer wheels TW1, TW2 are mounted on a single axle and are not steerable. The parking assist controller 4 may be used in conjunction with a towed vehicle 3 having more than one axle, for example a twin-axle trailer, and/or more than two trailer wheels.

As shown in FIGS. 1 and 2, the towing vehicle 2 is provided with a vehicle imaging system comprising a central towing vehicle camera 8, a left towing vehicle camera 9 and a right towing vehicle camera 10. The central towing vehicle camera 8 is mounted in a central position at the rear of the towing vehicle 2, for example in a rear bumper. The left towing vehicle camera 9 and the right towing vehicle camera 10 are mounted in respective left and right wing mirrors 11, 12 of the towing vehicle 2. The towing vehicle cameras 8, 9, 10 are optical cameras arranged to face in a rearwards direction, i.e. towards a region disposed at the rear of the towing vehicle 2. The fields of view V1, V2, V3 of the central towing vehicle camera 8, the left towing vehicle camera 9 and the right towing vehicle camera 10 are illustrated by dashed lines in FIGS. 1 and 2. The towing vehicle 2 also comprises an obstruction detection system for detecting the presence of an obstruction in the rear three quarters position of the towing vehicle 2. The obstruction detection system in the present embodiment comprises left and right radar systems 13A, 13B. The left and right radar sensors 13A, 13B are operative to detect obstructions in respective left and right detection regions 14A, 14B.

As shown in FIG. 1, the towed vehicle 3 is provided with a trailer imaging system comprising a rear trailer camera 15. The trailer imaging system may optionally comprise additional trailer cameras, for example one or more trailer cameras mounted on the sides of the towed vehicle 3. The rear trailer camera 15 is an optical camera arranged to provide a video image of an area behind the towed vehicle 3 which may otherwise be obscured from the driver's field of vision. The rear trailer camera 15 has a field of view TV1 which is illustrated by dashed lines. The towed vehicle 3 optionally also comprises an obstruction detection system, for example parking sensors 16A, 16B, for detecting obstructions in one or more detection regions at the rear of the towed vehicle 3 and/or at the sides of the towed vehicle 3. The image data from the rear trailer camera 15 and/or obstruction data from the obstruction detection system is transmitted to the towing vehicle 2 over a wired connection or a wireless connection.

The coupling between the towing vehicle 2 and the towed vehicle 3 is an articulated coupling. In the present embodiment, a tow hitch 17 is mounted to the towing vehicle 2 for connection to a trailer coupling 19 mounted to the towed vehicle 3. The tow hitch 17 in the present embodiment comprises an upwardly projecting tow ball. The trailer coupling 19 is mounted to a hitch frame 21 disposed at the front of the towed vehicle 3. In the present embodiment, the hitch frame 21 is an A-frame having a front apex to which the trailer coupling 19 is mounted. The angular orientation of the first longitudinal axis X1 of the towing vehicle 2 and the second longitudinal axis X2 of the towed vehicle 3 is referred to herein as a hitch angle ϕ. The towing vehicle 2 comprises a hitch angle determining means 24 for measuring the hitch angle ϕ. The hitch angle determining means 24 may comprise, for example, a mechanical sensor or an optical sensor. In the present embodiment, the hitch angle determining means 24 comprises an optical system for determining an angular orientation of a target 25 mounted to of the towed vehicle 3. The target 25 is mounted on the towed vehicle 3 within the field of view V1 of the central towing vehicle camera 8. The target 25 is a visible image comprising three circles arranged in a triangular formation. It will be appreciated that the present invention can be implemented with other targets 25, for example comprising different symbols/images or non-visible targets.

The parking assist controller 4 is configured to control the towing vehicle 2 to assist maneuvering of the towing vehicle 2 and the towed vehicle 3. The parking assist controller 4 is operative selectively to control the towing vehicle 2 to manoeuvre the combination of the towing vehicle 2 and the towed vehicle 3 to position the towed vehicle 3 (and optionally also the towing vehicle 2) in a predetermined target position P_{TAR}. The target position P_{TAR} defines a target location and/or a target orientation of the towed vehicle 3 for parking. As described herein, the parking assist controller 4 is operative to generate a parking assist signal S1 to control the towing vehicle 2 to guide the towed vehicle 3 to the target position P_{TAR}. The parking assist signal S1 provides automated or semi-automated control of the towing vehicle 2 to park the towed vehicle 3. In particular, the parking assist signal S1 is output to an electronic power assisted steering (EPAS) module 18 to control the steering angle θ of the front wheels W1, W2 of the towing vehicle 2. The parking assist signal S1 may optionally control a torque request signal which is output to a torque generating machine, such as an internal combustion engine or an electric machine; and/or a brake torque request signal to a braking apparatus. Alternatively, the parking assist signal S1 may be output to a human machine interface (HMI), for example comprising a display screen or a head up display (HUD), to provide instructions or prompts to the driver of the towing vehicle 2.

In known arrangements, the target position P_{TAR} may be specified using an HMI, for example by positioning a target parking position on a screen. A potential limitation of known arrangements is that it may prove difficult for a user to visualise the location of the towed vehicle 3 before completing the parking manoeuvre. The user may find it difficult to relate on-screen features on a display screen with the real-world counterparts. By way of example, if the towed vehicle 3 is a caravan, it may prove difficult for a user to align a charging point on the towed vehicle 3 with a mains electrical supply shown on a display screen. At least in certain embodiments, the parking assist controller 4 according to the present invention may overcome or reduce this problem. In particular, the parking assist controller 4 is configured to determine the target position P_{TAR} with reference to a parking location indicator 26 generated by a parking beacon 5. As described herein, the parking location indicator 26 in the present embodiment is projected onto the ground by one or more optical systems provided in the parking beacon 5.

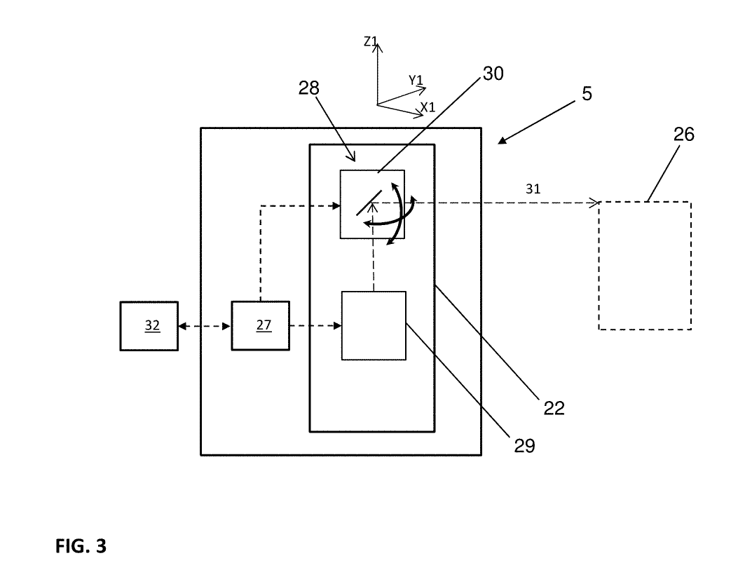

The parking beacon 5 is illustrated in FIG. 3. The parking beacon 5 is a portable device which may be free standing, for example comprising a tripod structure; or may comprise a spike (not shown) for insertion into the ground. The parking beacon 5 comprises a beacon control unit 27 and at least a first projection system 28 for projecting the parking location indicator 26 onto the ground. The first projection system 28 in the illustrated arrangement comprises a light source 29; and optical guide means 30. The optical guide means 30 is configured to define a light path for the light emitted from the light source 29. The optical guide means 30 in the present embodiment is controllable to adjust the light path of the light emitted from the light source 29. The optical guide means 30 in the present embodiment comprises a mirror 30. Other forms of optical guide may be used, such as a reflective prism. The light source 29 is configured to emit at least one light path 31 of visible light for projecting the parking location indicator 26. In use, the at least one light path 31 may be projected onto the ground so that the parking location indicator 26 is visible. The beacon control unit 27 controls the energization of the light source 29 and the orientation of the mirror 30 to form the parking location indicator 26. By changing the orientation of the mirror 30, the position and/or orientation and/or profile of the parking location indicator 26 may be controlled dynamically. The at least one light path 31 provides a visual representation of a position and/or orientation and/or profile of the target position P_{TAR} for the towed vehicle 3. The light source 29 is described herein as emitting a single light path 31 of light, but the parking beacon 5 may emit multiple light paths 31, for example to represent two or more sides of the target position P_{TAR}. The first projection system 28 may optionally include optics, such as one or more lenses, to focus the light emitted from the light source 29.

The light source 29 comprises at least one laser diode. The mirror 30 is an optical mirror configured to reflect the light emitted from the light source 29. The mirror 30 can be oriented so as to direct the light path 31 downwardly (relative to a vertical axis of the parking beacon 5) so that is incident on the ground. The mirror 30 in the present embodiment is a scanning mirror and the orientation of the mirror 30 is adjustable dynamically to modulate the emitted light. The mirror 30 may, for example, comprise a micro-opto-electromechanical system (MOEMS). The mirror 30 pivots about at least one axis to modulate the emitted light, thereby forming the visible representation of the parking location indicator 26. In the present embodiment, the mirror 30 is pivotable about a first pivot axis X1 and a second pivot axis Z1, arranged perpendicular to each other, to enable the light path 31 to be controlled in first and second directions. The mirror 30 may optionally also be pivotable about a third pivot axis Y1, arranged perpendicular to the first pivot axis X1 and the second pivot axis Z1. The beacon control unit 27 is configured to control the orientation of the mirror 30 to trace the profile of the parking location indicator 26. By controlling the orientation of the mirror 30, the light path 31 may scan a visible pattern representing the parking location indicator 26. The beacon control unit 27 controls the mirror 30 to project the light path 31 onto the ground so that the parking location indicator 26 is visible. The beacon control unit 27 may selectively activate and deactivate the light source 29 to generate a continuous or interrupted trace. The parking location indicator 26 in the present embodiment comprises a rectangular frame corresponding to an outer perimeter of the target position P_{TAR}. The beacon control unit 27 may optionally modulate the light source 29 to encode the light path 31. The modulation of the light source 29 may, for example, comprise selectively activating and deactivating in a predetermined pattern which is identifiable by the parking assist controller 4.

The beacon control unit 27 controls the energization of the light source 29 and the orientation of the mirror 30 to form the parking location indicator 26. By changing the orientation of the mirror 30, the parking location indicator 26 is projected onto the ground to provide a visual representation of the target position P_{TAR}. The light path 31 projected by the parking beacon 5 may, for example, be controlled to define a side of the target position P_{TAR}. The mirror 30 may be controlled to highlight one or more features, for example the extremities of the target position P_{TAR}. As outlined above, the parking beacon 5 may generate more than one light path 31 of light. For example, the parking beacon 5 may emit two (2) light paths 31 of visible light suitable for representing adjacent or opposing boundaries of the target position P_{TAR}. The light paths 31 could both be the same colour of light (same wavelength), or may be different colours of light (different wavelength) to differentiate between different features. Alternatively, or in addition, the parking assist system 1 described herein could comprise a plurality of parking beacons 5.

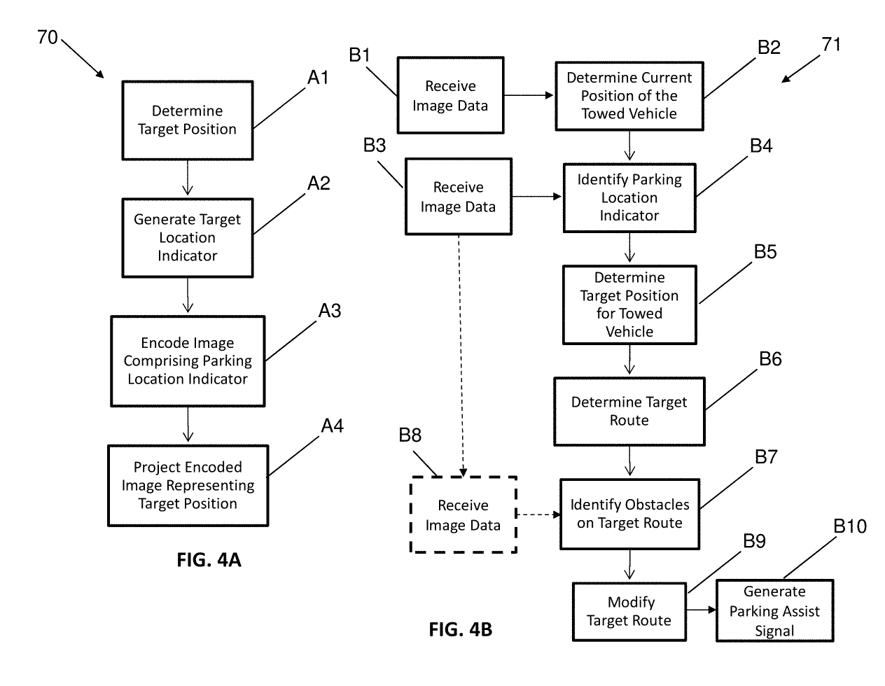

The operation of the beacon control unit 27 is illustrated with reference to a block diagram 70 shown in FIG. 4A. The beacon control unit 27 determines the target position P_{TAR} for parking the towed vehicle 3 (BLOCK A1). The beacon control unit 27 generates an image comprising the parking location indicator 26 (BLOCK A2). The image is encoded to facilitate identification (BLOCK A3). The beacon control unit 27 controls the first projection system 28 to project the encoded image (BLOCK A4).

The light source 29 and the mirror 30 may optionally be mounted to an adjustable mounting assembly 22. The mounting assembly 22 may enable manual or automatic adjustment in a in a vertical plane and/or rotation about a vertical axis. The adjustable mounting assembly 22 may optionally comprise a self-levelling apparatus, such as a gimbal. The self-levelling apparatus may ensure a reference level for the projection of the parking location indicator 26.

As outlined above, the parking location indicator 26 is visible and allows a user to position and/or orient the target position. In the arrangement described herein, the parking location indicator 26 comprises a single line which is traced by scanning the light path 31. This line defines a boundary of the parking location indicator 26 and is used to determine the target position P_{TAR} for parking the towed vehicle 3. The parking beacon 5 may be modified to generate two (2) or more lines, for example arranged orthogonally to define a corner of the parking location indicator 26. Alternatively, the parking beacon 5 may generate a box or frame representing the boundaries of the parking location indicator 26. The beacon control unit 27 may be configured to match the size of the parking location indicator 26 to the actual size of the towed vehicle 3 and/or the towing vehicle 2 (for example by direct entry of the dimensions and/or transfer from the vehicle/trailer system). In a further modification, the beacon control unit 27 may control the mirror 30 to trace additional details, for example to indicate the location of features of the towed vehicle 3, such as a wheel(s), a drainage point(s), an electrical connection, a door, a hitch etc. Alternatively, or in addition, the parking location indicator 26 may include features representing the position of a lowered tailgate or a side door (for example, if the towed vehicle 3 is a horsebox). In a modified arrangement, the parking beacon 5 may project a plurality of spots (point illuminations) to represent the parking location indicator 26. The parking location indicator 26 may, for example, by represented by four (4) spots corresponding to the corners of the target position P_{TAR}. By composing the parking location indicator 26 of one or more spots, the parking location indicator 26 may be detectable in a wider range of operating conditions, for example in bright sunlight. A less powerful laser diode may be used to form the parking location indicator 26.

The parking beacon 5 comprises a beacon human machine interface (HMI) 32 to enable the user to control operation of the parking beacon 5. The beacon HMI 32 may, for example, enable the user to specify a particular orientation and/or location of the parking location indicator 26 to be projected onto the ground. The beacon HMI 32 could be implemented by a software application operated on a separate computational device, such as a cellular telephone or personal computer, connected over a wired or wireless communication channel. It is envisaged that a short-range wireless communication channel would provide a suitable connection to the parking beacon 5. In the present embodiment, the beacon control unit 27 is operative to control the light source 29 to encode a signal into the parking location indicator 26. The encoded signal may be an identification signal to facilitate detection and/or identification of the parking location indicator 26. For example, to facilitate orientation, the projected lines may be pulsed to generate a code which differentiates between a longitudinal line and a lateral line. The pulse codes may be extended to convey other information such as trailer identification and/or trailer type and/or absolute dimension of the trailer.

Alternatively, or in addition, the encoded signal may comprise data relating to the dimensions and/or configuration of the towed vehicle 3. The parking beacon 5 may optionally comprise means for sensing the towed vehicle 3, such as a proximity sensor, to provide feedback to the parking assist controller 4. The parking beacon 5 may optionally comprise a camera for transmitting image data to the parking assist controller 4, for example to provide an alternate view of the region behind the towed vehicle 3.

The parking assist controller 4 provided in the towing vehicle 2 comprises an electronic control unit (ECU) 33 having an electronic processor 34 and a memory 35, as shown schematically in FIG. 2. The electronic processor 34 is configured to execute a set of computational instructions stored on the memory 35. The processor 34 comprises image processing means for analysing image data generated by the towing vehicle cameras 8, 9, 10 and the trailer camera(s) 15.

The processor 34 comprises a first image processing module 36A for receiving the image data from the central towing vehicle camera 8. The first image processing module 36A is configured to analyse the image data to determine the position and/or orientation of the target 25 mounted to the towed vehicle 3. By determining the position and/or orientation of the target 25, the first image processing module 36A determines the hitch angle ϕ of the towed vehicle 3. The first image processing module 36A thereby performs the function of the hitch angle determining means 24 in the present embodiment. The first image processing module 36A thereby determines a current position P_{CUR} of the towed vehicle 3.

The processor 34 comprises a second image processing module 36B for receiving image data from the left and right towing vehicle cameras 9, 10 and the rear trailer camera 15. The second image processing module 36B is configured to analyse the image data to identify the parking location indicator 26 generated by the parking beacon 5. In particular, the second image processing module 36B processes the image data to identify any elements in the image data which change in accordance with the encoded signal introduced by the beacon control unit 27. The second image processing module 36B may thereby identify the parking location indicator 26. The processor 34 determines the target position P_{TAR} for parking the towed vehicle 3 in dependence on the parking location indicator 26. In the illustrated arrangement, the light path 31 generated by the parking beacon 5 indicates a side boundary of the target position P_{TAR} and a longitudinal extent of the target position P_{TAR}. In a variant, the light path 31 generated by the parking beacon 5 may represent a centerline of the target position P_{TAR}. The ends of the parking location indicator 26 represent the front and rear extremities of the target position P_{TAR}.

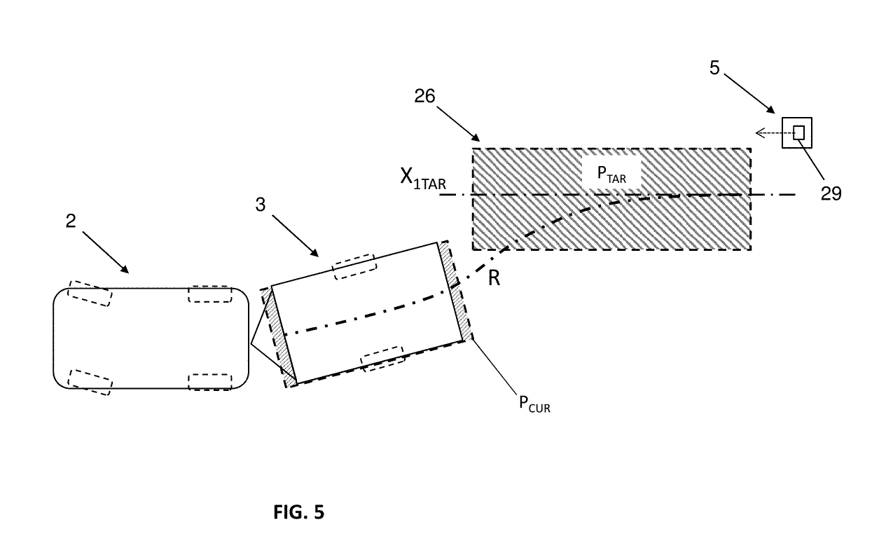

The processor 34 further comprises vehicle/trailer guidance means in the form of a guidance module 36C. The guidance module 36C is provided to assist with reversing the combination of the towing vehicle 2 and the towed vehicle 3. In particular, the guidance module 36C is configured to output a control signal for controlling the steering angle θ of the front wheels W1, W2 of the towing vehicle 2 to guide the towed vehicle 3 along a target route (or trajectory) R. The target route R is generated by the guidance module 36C to guide the towed vehicle 3 from a current position P_{CUR} to the target position P_{TAR}. The target route R is illustrated by a broken line in FIG. 5. The guidance module 36C is configured to generate the target route R to guide the towed vehicle 3 from the current position P_{CUR} to the identified target position P_{TAR}. The target route R defines a trajectory for the towed vehicle 3 from the current position P_{CUR} to the target position P_{TAR}. The target route R can comprise rectilinear and/or curved sections. The target route R is arranged coincident with a midpoint of the towed vehicle 3 in the current position P_{CUR}. The current position P_{CUR} of the towed vehicle 3 is monitored compared to the originally calculated target route R. Small deviations are managed within the parking assist controller 4. Larger deviations can trigger a recalculation of the target route R. If the target position P_{TAR} becomes unachievable from the current position P_{CUR}, the user is alerted and a corrective manoeuvre is suggested (for example travel forward a short distance).

The processor 34 comprises a third image processing module 36D configured to identify obstacles in the trajectory of the towing vehicle 2 and the towed vehicle 3. The third image processing module 36D may receive detection signals from the left and right radar systems 13A, 13B to identify the presence/absence of obstructions proximal to the towing vehicle 2 and the towed vehicle 3. In particular, the third image processing module 36D is configured to identify obstructions along the target route R of the towing vehicle 2 and/or the towed vehicle 3.

The operation of the processor 34 is illustrated with reference to a block diagram 71 shown in FIG. 4B. The processor 34 receives the image data from the central towing vehicle camera 8 (BLOCK B1). The first image processing module 36A analyses the image data to determine a current position P_{CUR} of the towed vehicle 3 (BLOCK B2). The processor 34 receives the image data from the left and right towing vehicle cameras 9, 10 and the rear trailer camera 15 (BLOCK B3). The second image processing module 36B analyses the image data to identify the parking location indicator 26 (BLOCK B4). The processor 4 uses the parking location indicator 26 to determine the target position P_{TAR} of the towed vehicle 3 (BLOCK B5). The guidance module 36C determines the target route R from the current position P_{CUR} to the target position P_{TAR} (BLOCK B6). The third image processing module 36D identifies obstacles along the target route R (BLOCK B7). The third image processing module 36D may optionally receive additional image data from one or more cameras provided on the towing vehicle 2 and the towed vehicle 3 (BLOCK B8). If required, the guidance module 36C may modify the target route R to avoid any obstacles identified by the third image processing module 36D (BLOCK B9). It will be understood that any obstacles may be identified prior to generation of the target route R. The parking assist signal S1 comprising the modified target route R is output (BLOCK B10).

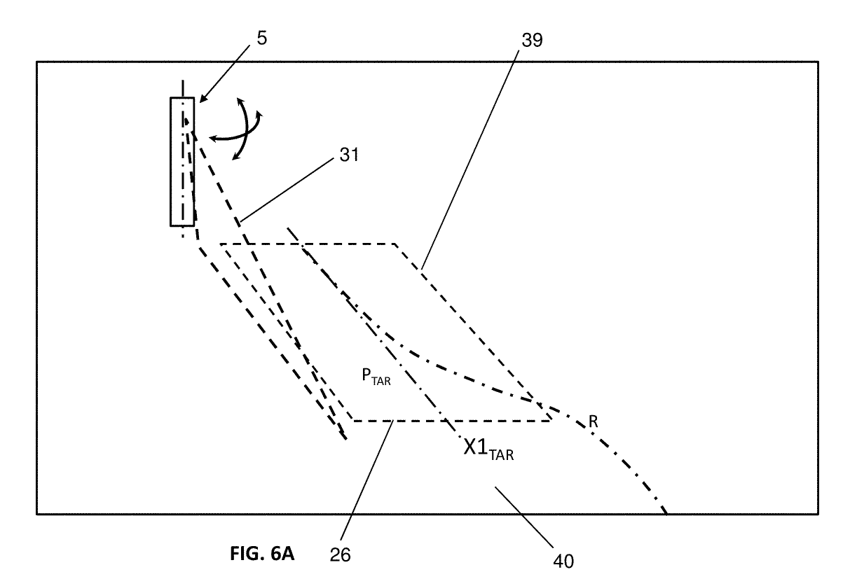

The parking assist controller 4 comprises a human machine interface (HMI) 37. The controller HMI 37 in the present embodiment is provided in the towing vehicle 2, but could be provided in the towed vehicle 3. The controller HMI 37 comprises a display screen 38 and is configured to display a target position indicator 39 representing the target position P_{TAR}. In the present embodiment, the target position indicator 39 is superimposed onto an image 40 received from the central towing vehicle camera 8 and/or the rear trailer camera 15. As illustrated in FIG. 6A, the target position indicator 39 is illustrated as a rectangle representing the footprint of the towing vehicle 2 and the towed vehicle 3 in combination. The target position indicator 39 is sized to provide a scale representation of the towing vehicle 2 and the towed vehicle 3 within the image 40. The dimensions of the towing vehicle 2 are defined in a data file accessible to the parking assist controller 4. To provide an accurate representation of the towed vehicle 3, the trailer dimensions can be specified by the user and stored in the data file. The controller HMI 37 may optionally comprise input means 41 which can be operated by the user to adjust the position of the target position indicator 39 within the image 40. The input means 41 could comprise a touch sensitive screen and/or a rotary dial, for example. If required, the user can adjust or refine the position of the target position P_{TAR} determined by the second image processing module 36B. The controller HMI 37 could optionally also be configured to allow the user to adjust the target route R generated by the guidance module 36C.

The controller HMI 37 may optionally also enable the user to specify the position and/or size of one or more features of the towed vehicle 3. As shown in FIG. 6B, the image 40 output by the controller HMI 37 may provide a graphical representation of the towed vehicle 3. The representation of the towed vehicle 3 may include one or more markers representing features of the towed vehicle. The image 40 may comprise one or more of the following set: a door marker 42, an electrical connector marker 43, an A-frame marker 44, a guide wheel (not shown) and a retractable (support) member (not shown). The image 40 may show the position and/or size of the features, for example in an open state and/or a closed state. The image 40 may, for example, comprise a birds-eye view of the towed vehicle 3. The birds-eye view may be a composite of multiple images captured by the cameras 8, 9, 10, provided on the towing vehicle 2 and/or the camera 15 provided on the towed vehicle 3. The controller HMI 37 may be configured to allow the user to define the various features of the towed vehicle 3. Alternatively, a model of the towed vehicle 3 may be pre-defined, for example stored in a database accessed by the parking assist controller 4. By including the features of the towed vehicle 3 in the image 40, the user may more readily select the target position P_{TAR}. For example, the user may select the target position P_{TAR} so as to position the electrical connector marker 43 proximal to a power point.

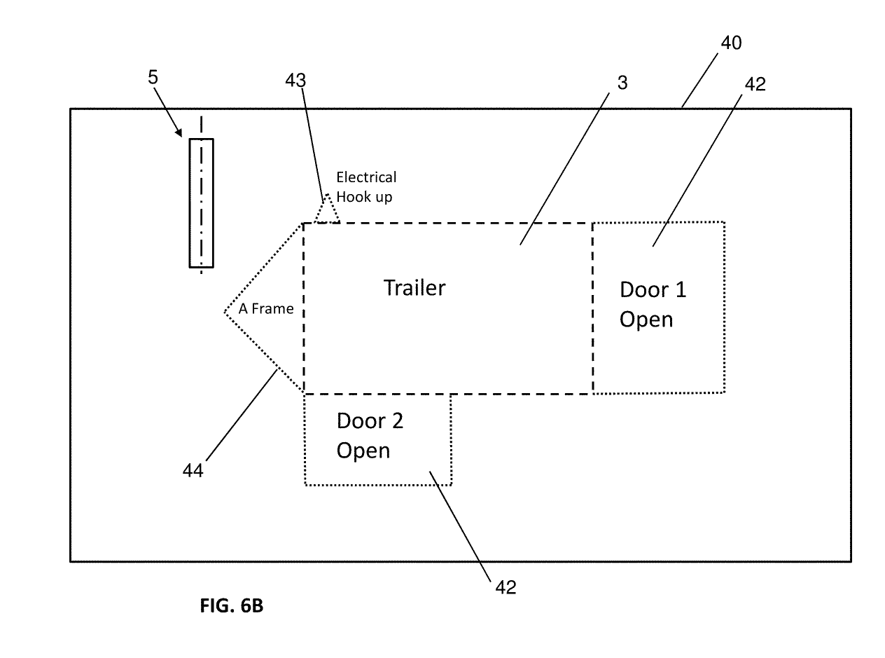

The operation of the controller HMI 37 is illustrated with reference to a block diagram 72 shown in FIG. 7. The controller HMI 37 determines the target position P_{TAR} (BLOCK C1). As described herein, the target position P_{TAR} may be determined by analysing image data to identify the parking location indicator 26 projected by the first projection system 28 (BLOCK C2). Alternatively, or in addition, the target position P_{TAR} may be determined by user input (BLOCK C3). The controller HMI 37 receives the image data from the left and right towing vehicle cameras 9, 10 and the rear trailer camera 15 (BLOCK C4). The image data is displayed on the display screen 38 (BLOCK C5). The target position indicator 39 is overlaid onto the image (BLOCK C6). A user input is received, for example via user interaction with the touch screen, to adjust the position of the target position indicator 39 (BLOCK C7). In dependence on the received user inputs, the controller HMI 37 adjusts the location of the target position indicator 39 within the image (BLOCK C8). The user validates the location of the target position indicator 39 and, as described herein, the target route R is generated (BLOCK C9). The target route R may then be overlaid onto the image to provide a graphical representation (BLOCK C10). The target route R may optionally be modified, for example in dependence on user inputs (BLOCK C11).

The first projection system 28 may be configured to project the features of the towed vehicle 3 along with the parking location indicator 26. For example, the first projection system 28 may project the features onto the ground to facilitate selection of the target position P_{TAR} for the towed vehicle 3.

In use, the user positions the parking beacon 5 externally of the towing vehicle 2 and the towed vehicle 3. The parking beacon 5 is typically placed on the ground. The first projection system 28 is activated to project the parking location indicator 26. The parking location indicator 26 is projected onto the ground to provide an at least substantially full-size representation (i.e. a 1:1 representation) of the target position (P_{TAR}). The user configures the first projection system 28 such that parking location indicator 26 corresponds to a desired target position P_{TAR}. The user may manually configure the first projection system 28 or may utilise the HMI 37 to set the location of the parking location indicator 26. The parking location indicator 26 is projected onto the ground and thereby provides a visible indication of the target position P_{TAR}. In the present embodiment, the parking location indicator 26 represents a boundary of the target position P_{TAR}.

The guidance module 36C determines a current position P_{CUR} of the towed vehicle 3 in dependence on the hitch angle ϕ of the towed vehicle 3 determined by the first image processing module 36A. The guidance module 36C operates to determine the target route R between the current trailer position and the target position P_{TAR}. The vehicle steering angle θ is controlled such that a centre of rotation of the towed vehicle 3 at least substantially matches the determined target route R. The guidance module 36C implements a geometric algorithm to generate the target route R. The guidance module 36C may, for example, utilise the angular offset between the current trailer longitudinal axis X2 and the target longitudinal axis X1_{TAR}; and the lateral offset between the current trailer position and the parking destination P_{TAR}. The guidance module 36C can optionally be configured to define a minimum radius of curvature for the first and second curves A, B to ensure that the hitch angle ϕ does not equal or exceed the jack-knife angle.

The parking assist controller 4 attempts to identify the presence of any obstructions along the target route R. Typical obstructions include kerbs, walls, vehicles, etc. The parking assist controller 4 can optionally also determine terrain features. The terrain features may comprise one or more of the following set: an incline or gradient of the surface; surface roughness, for example to differentiate between a smooth surface and a rough or uneven surface. As described herein, the obstructions may be identified by the third image processing module 36D. The guidance module 36C modifies the target route R to avoid any obstructions identified by the third image processing module 36D.

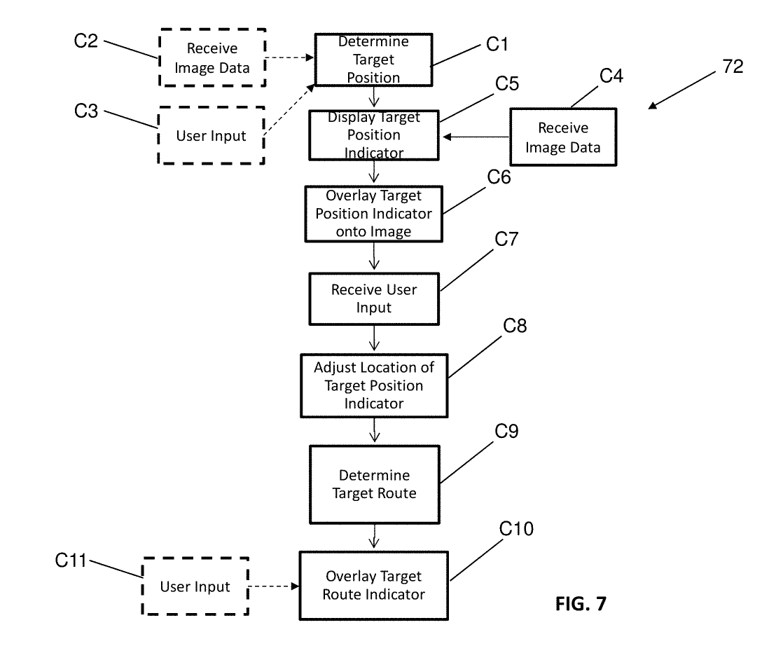

The steering angle θ of the towing vehicle 2 is controlled to maintain a travel direction of the towed vehicle 3 substantially coincident with a target trailer travel direction while reversing along said target route R. The guidance module 36C controls the steering angle θ of the front wheels W1, W2 to guide the towed vehicle 3 along the target route R. The control algorithm for generating a control signal to guide the towing vehicle 2 along the target route R will now be described with reference to FIG. 8. The towing vehicle 2 has a first longitudinal axis X1 and the towed vehicle 3 has a second longitudinal axis X2. The angular offset between the first and second longitudinal axes X1, X2 is referred to as the hitch angle ϕ. During reversing, the towed vehicle 3 travels in a direction TACT corresponding to the hitch angle ϕ (unless the hitch angle ϕ exceeds a jack-knife angle for the towed vehicle 3).

The first image processing module 36A calculates the hitch angle ϕ with reference to the target 25 and outputs a hitch angle signal to the guidance module 36C. When reversing, the guidance module 36C calculates the required steering angle ϕ based on the following equation:

θₜ₊₁=θₜ+min(max(k(ϕ_{req}−ϕ_{cur}),−α),α)

Where:
θₜ₊₁ and θₜ are the steering angles of the towing vehicle 2 at frame t+1 and t (auto steering command from the algorithm and current steering from the CAN respectively);
ϕ_{req} and ϕ_{cur} are the requested and current hitch angles;
α is the maximum steering offset value; and
k is a constant multiplier.

The maximum steering offset value a defines a maximum change (offset) in the steering angles within the defined time period (i.e. within the time frame t to t+1). The maximum steering offset value a thereby defines a slew rate limit. The value of the gain k can be calculated based on the relationship between θ and ϕ, as shown in FIG. 8. When the trailer hitch length L plus the tow bar offset of the vehicle h is equal to the vehicle wheelbase d, then the relationship between θ and ϕ is one (1) for small angles and so the gain k can be set to a value of one (1). The gain k can therefore be calculated based on the following equation:

$$k = \frac{L + h}{d}$$

Where:
L is the hitch length of the towed vehicle 3;
h is the tow bar offset of the towing vehicle 2;
d is the wheelbase of the towing vehicle 2;

The gain k thereby compensates for the fact that longer trailers take longer to reach the requested hitch angle ϕ.

The guidance module 36C is configured to calculate a maximum permissible hitch angle ϕ_{MAX}. If the hitch angle ϕ exceeds the maximum permissible hitch angle ϕ_{MAX} (which in the present embodiment is the jack-knife angle of the towed vehicle 3), it is no longer possible to reduce the hitch angle ϕ by continuing to reverse (i.e. the towed vehicle 3 has jack-knifed). If the detected hitch angle ϕ is equal to or exceeds the calculated jack-knife angle, the parking assist controller 4 will advise the user to drive forward until it determines that the trailer angle δ or hitch angle ϕ at the next interval is achievable while considering space and obstructions. With reference to FIG. 8, the guidance module 36C calculates the maximum permissible hitch angle ϕ_{MAX} by applying the following set of equations:

$$R = \frac{d}{tan ( θ )}$$

$$φ = {cos}^{- 1} ( \frac{- Lh + R \sqrt{{R}^{2} + {h}^{2} - {L}^{2}}}{{R}^{2} + {h}^{2}} )$$

$$for positive θ$$

$$φ = - {cos}^{- 1} ( \frac{- Lh - R \sqrt{{R}^{2} + {h}^{2} - {L}^{2}}}{{R}^{2} + {h}^{2}} )$$

$$for negative θ$$

Where:
R is the turning radius;
θ is the steering angle of the towing vehicle 2;
d is the wheelbase of the towing vehicle 2;
h is the tow bar offset of the towing vehicle 2;
L is the hitch length of the towed vehicle 3;

The wheelbase d, the tow bar offset h and the maximum steering angle θ_{MAX} of the towing vehicle 2 are defined for the towing vehicle 2. The hitch length L of the towed vehicle 3 is entered during setup by the user (or can be determined during a calibration exercise). The guidance module 36C outputs a maximum hitch angle signal to indicate the maximum permissible hitch angle ϕ_{MAX} for the current steering angle θ. The guidance module 36C is configured to inhibit the trailer travel direction to values which are less than the maximum permissible hitch angle ϕ_{MAX}. A minimum radius of curvature of the target route R can be defined to ensure that the trailer travel direction is less than or equal to the maximum permissible hitch angle ϕ_{MAX}.

The guidance module 36C calculates the initial required steering angle θ to achieve the desired hitch angle ϕ, then iteratively calculates the required steering angle θ and hitch angle ϕ. In use, the guidance module 36C is configured to output a steering control signal operative to control the steering angle θ of the front wheels W1, W2 to adjust the hitch angle ϕ, thereby modifying the actual trailer travel direction. Specifically, the guidance module 36C adjusts the steering angle θ (which can be positive or negative in relation to a reference point) to increase or decrease the hitch angle ϕ. The actual trailer travel direction can thereby be matched to the target trailer travel direction required to follow the target route R. The hitch angle signal is updated at least substantially in real time and the guidance module 36C makes corresponding real time adjustments to the steering control signal. The guidance module 36C controls the hitch angle ϕ so that the difference between the actual trailer travel direction and the target trailer travel direction is at least substantially zero. A tolerance of +/−0.5° between the actual trailer travel direction and the target trailer travel direction provides a good result.

A parking control signal S1 is output by the guidance module 36C to the EPAS 18 to adjust the steering angle θ to control the towing vehicle 2 to match the actual travel direction of the towed vehicle 3 with the target travel direction. The controller HMI 37 can optionally output instructions to prompt the user to select the appropriate drive gear and to operate the vehicle brakes and throttle. The EPAS 18, in dependence on the parking control signal S1 output from the guidance module 36C, steers the towing vehicle 2 to guide the towed vehicle 3 along the target route R. A notification can be output by the controller HMI 37 to notify the user when the towing vehicle 2 and the towed vehicle 3 are in the target position P_{TAR}. The parking assist controller 4 can thereby facilitate reversing the towing vehicle 2 and the towed vehicle 3 to the target position P_{TAR}.

The present invention is applicable to a range of different types of towed vehicle 3. For example, the towed vehicle 3 can be a trailer, a caravan, a goods trailer, a flatbed trailer, a van trailer, a livestock trailer, a horsebox and so on. Similarly, the present invention is applicable to a range of different types of towing vehicles 2. For example, the towing vehicle 2 can be a motor vehicle, such as a utility vehicle, an off-road vehicle, a sports utility vehicle (SUV); or a towing engine or tractor for a semi-trailer truck.

Furthermore, although the parking assist controller 4 has been described with reference to a set of towing vehicle cameras 8, 9, 10, it will be appreciated that one or more of the cameras may be omitted. For example, the left and right towing vehicle cameras 9, 10 could be omitted. Alternatively, or in addition, more than one camera may be provided on the towed vehicle 3, for example left and right cameras may be mounted to the towed vehicle 3. In a further alternative, the towing vehicle cameras 8, 9, 10 or the rear trailer camera 15 could be used exclusively. A set of parking sensors provided on the towed vehicle 3 may provide notification to the driver of any obstructions. The hitch angle ϕ could be measured directly, for example by a rotary encoder.

The parking assist controller 4 could be used to assist with the parking of a vehicle which is not being towed. The parking assist controller 4 may be configured to facilitate parking of a host vehicle. The parking assist controller 4 may be configured to identify the parking location indicator 26 generated by the parking beacon; and determine the target position P_{TAR} for parking the vehicle 2. The parking assist controller 4 may generate a parking assist signal for parking the vehicle 2 in dependence on the determined target position P_{TAR}. The parking assist controller 4 may generate a target route R for parking the vehicle 2. The parking assist signal may provide partial or fully autonomous control of the vehicle 2. This parking assist controller 4 could be installed on a trailer incorporating an on-board drive mechanism, for example comprising one or more electric machines for driving the wheels of the trailer.

As described herein, the controller HMI 37 is provided in the towing vehicle 2 to control operation of the parking assist system 1. Alternatively, or in addition, the beacon HMI 32 may be configured to control operation of the parking assist system 1. The beacon HMI 32 may, for example, comprise a display screen and user input means. At least in certain embodiments the beacon HMI 32 may enable activation of a “Park Now” control function. When activated, the “Park Now” control function may initiate an automated parking sequence to cause the towing vehicle 2 to reverse the towed vehicle 3 along the target route R. The parking assist system 1 may be configured to require positive activation of the beacon HMI 32 by the user in order to continue the automated control of the towing vehicle 2. For example, the parking assist system 1 may be configured to bring the towing vehicle 2 to a stop upon determining that the user is no longer activating the beacon HMI 32. For example, if the user releases an activation button or a touch sensor provided in the beacon HMI 32, the parking assist system 1 may be configured to stop the towing vehicle 2. This control strategy may provide an additional safety requirement for the movement to cease in the event of an unsafe condition arising. The beacon HMI 32 may provide additional control functions, for example to enable a user to preview one or more target routes R, for example by scrolling or cycling through optional routes. The user may then operate the beacon HMI 32 to select one of the previewed target routes R for the towing vehicle 2 to follow. It will be understood that the control functions of the beacon HMI 32 may also be provided in the controller HMI 37 provided in the towing vehicle 2.

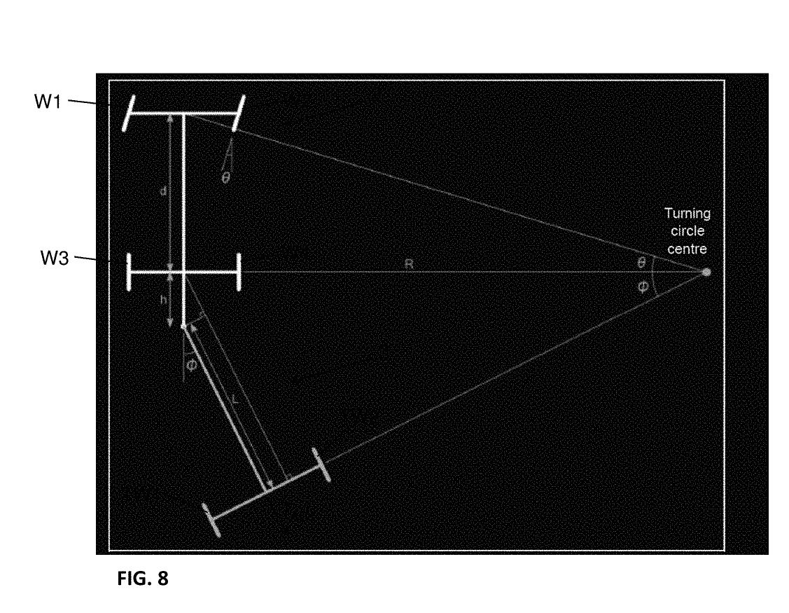

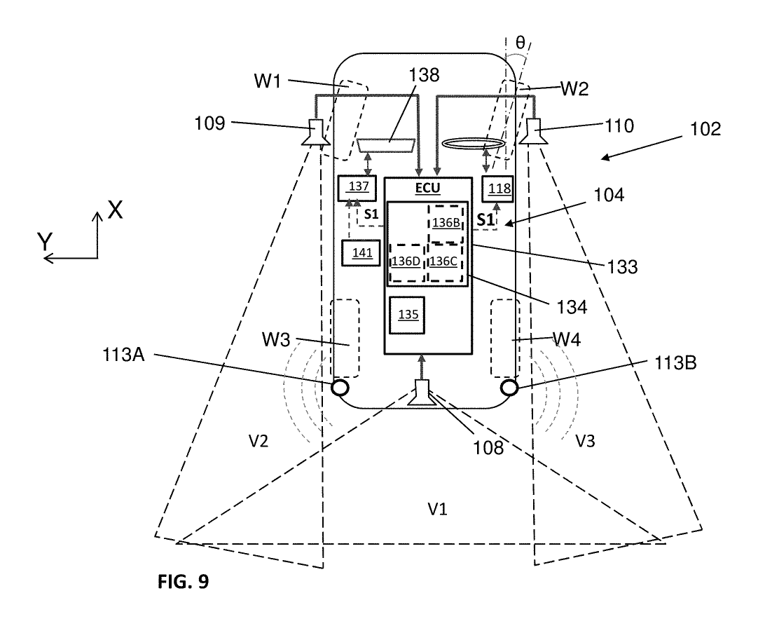

A parking assist system 101 in accordance with a further embodiment of the present invention in which the parking assist controller 4 is configured to control a host vehicle 102 will now be described with reference to FIGS. 9 and 10. Like reference numerals are used for like components, albeit incremented by 100 to aid comprehension. The host vehicle 102 may, for example be in the form of an automobile, a utility vehicle or a sports utility vehicle (SUV).

The parking assist controller 104 is operative selectively to control the host vehicle 102 to manoeuvre the host vehicle 102 to a predetermined target position P_{TAR}. The target position P_{TAR} defines a target location and/or a target orientation of the host vehicle 102 for parking. As described herein, the parking assist controller 104 is operative to generate a parking assist signal S1 to control the host vehicle 102 to the target position P_{TAR}. The parking assist signal S1 provides semi-autonomous control of the host vehicle 102. In particular, the parking assist signal S1 is output to an electronic power assisted steering (EPAS) module 118 to control the steering angle θ of the front wheels W1, W2 of the host vehicle 102. The parking assist signal S1 may optionally control a torque request signal which is output to a torque generating machine, such as an internal combustion engine or an electric machine; and/or a brake torque request signal to a braking apparatus. Alternatively, the parking assist signal S1 may be output to a human machine interface (HMI), for example comprising a display screen or a head up display (HUD), to provide instructions or prompts to the driver of the host vehicle 102. The parking assist controller 104 is configured to determine the target position P_{TAR} with reference to a parking location indicator 126 generated by the parking beacon 105.

The parking location indicator 126 in the present embodiment is projected onto the ground by at least a first projection system 128 provided in a parking beacon 105. The parking beacon 105 is unchanged from the embodiment described herein with preference to FIGS. 1 to 7. In particular, the first projection system 128 is configured to project the parking location indicator 126. A beacon control unit 127 is provided to control the first projection system 128 to encode a signal into the parking location indicator 126. The encoded signal may be an identification signal to facilitate detection and/or identification of the parking location indicator 126. The parking beacon 105 may optionally comprise means for sensing the host vehicle 102, such as a proximity sensor, to provide feedback to the parking assist controller 104. The parking beacon 105 may optionally comprise a camera for transmitting image data to the parking assist controller 104, for example to provide an alternate view of the region behind the host vehicle 102.

The parking assist controller 104 provided in the host vehicle 102 comprises an electronic control unit (ECU) 133 having an electronic processor 134 and a memory 135, as shown schematically in FIG. 9. The processor 134 is configured to execute a set of computational instructions stored on the memory 135. The processor 134 comprises image processing means for analysing image data generated by one or more cameras disposed on the host vehicle 102. In the present embodiment, a central host vehicle camera 108 is disposed in a central position; and left and right host vehicle cameras 109, 110 are disposed in respective left and right positions on the host vehicle 102. The processor 134 is configured to receive image data from each of the host vehicle cameras 108, 109, 110. The processor 134 may be configured also to receive data from other sensors disposed on the host vehicle 102. The processor 134 may, for example, receive data from one or more of the following: ultrasonic sensors, radar systems 113A, 113B and Lidar sensors.

The processor 134 comprises an image processing module 136B for receiving image data from the host vehicle cameras 108, 109, 110. The image processing module 136B is configured to analyse the image data to identify the parking location indicator 126 generated by the parking beacon 105. In particular, the image processing module 136B processes the image data to identify any elements in the image data which change in accordance with the encoded signal introduced by the beacon control unit 127. The image processing module 136B may thereby identify the parking location indicator 126. The processor 134 determines the target position P_{TAR} for parking the host vehicle 102 in dependence on the parking location indicator 126. In the illustrated arrangement, the light path 131 generated by the parking beacon 105 indicates a side boundary of the target position P_{TAR} and a longitudinal extent of the target position P_{TAR}. In a variant, the light path 131 generated by the parking beacon 105 could represent a centerline of the target position P_{TAR}. The ends of the parking location indicator 126 represent the front and rear extremities of the target position P_{TAR}.

The processor 134 further comprises vehicle guidance means in the form of a guidance module 136C. The guidance module 136C is provided to assist in guiding the host vehicle 102, for example to reverse the host vehicle 102 from a current position P_{CUR} to a target position P_{TAR}. The target position P_{TAR} may, for example, be a target parking position for the towed vehicle 303 (and optionally also the towing vehicle 302). It will be understood that the guidance module 136C could also be used to drive the host vehicle 102 into a target parking position while travelling in a forward direction. The guidance module 136C is configured to output a control signal for controlling the steering angle θ of the front wheels W1, W2 of the host vehicle 102 along a target route (or trajectory) R. The target route R is generated by the guidance module 36C to guide the host vehicle 102 from the current position P_{CUR} to the target position P_{TAR}. The target route R is illustrated by a broken line in FIG. 10. The guidance module 136C is configured to generate the target route R to guide the host vehicle 102 from its current location to the identified target position P_{TAR}. The target route R defines a trajectory for the host vehicle 102 from the current position P_{CUR} to the target position P_{TAR}. The target route R can comprise rectilinear and/or curved sections. The target route R is arranged coincident with a midpoint of the host vehicle 102. The current position P_{CUR} of the host vehicle 102 is monitored continuously and compared to the originally calculated target route R. Small deviations are managed within the parking assist controller 104. Larger deviations can trigger a recalculation of the target route R. If the target position P_{TAR} becomes unachievable from the current position P_{CUR}, the user is alerted and a corrective manoeuvre is suggested (for example travel forward a short distance).

The processor 134 comprises an obstacle detection module 136D configured to identify obstacles in the trajectory of the host vehicle 102. In particular, the obstacle detection module 136D is configured to identify obstructions along the target route R of the host vehicle 102. The obstacle detection module 136D may analyse image data received from the host vehicle cameras 8, 9, 10 to identify the presence/absence of obstructions, particularly along or proximal to the target route R. Alternatively, or in addition, the obstacle detection module 136D may receive detection signals from the left and right radar systems 113A, 113B to identify the presence/absence of obstructions proximal to the towing vehicle 2 and the towed vehicle 3.

The controller HMI 137 may optionally comprise input means 141 which can be operated by the user to adjust the position of the target position indicator 139 within an image output to a display screen 138. The input means 141 could comprise a touch sensitive screen and/or a rotary dial, for example. If required, the user can adjust or refine the position of the target position P_{TAR} determined by the image processing module 136B. The controller HMI 137 could optionally also be configured to allow the user to adjust the target route R generated by the guidance module 136C.

In use, the user positions the parking beacon 105 externally of the host vehicle 102. The parking beacon 5 is typically placed on the ground. The first projection system 128 is activated to project the parking location indicator 126. The user configures the first projection system 128 such that parking location indicator 126 corresponds to a desired target position P_{TAR}. The user may manually configure the first projection system 128 or may utilise the controller HMI 137 to set the location of the parking location indicator 126. The parking location indicator 126 is projected onto the ground and thereby provides a visible indication of the target position P_{TAR}. In the present embodiment, the parking location indicator 126 represents a boundary of the target position P_{TAR}.

The image processing module 136B analyses the image data from the host vehicle cameras 108, 109, 110 to identify the parking location indicator 126 generated by the parking beacon 105. In particular, the image processing module 136B processes the image data to identify the parking location indicator 26. The second image processing module 36B may optionally process the image data to identify an encoded signal introduced by the beacon control unit 127. The identification of the encoded signal may facilitate identification of the parking location indicator 26 within the image data. The image processing module 136B thereby identifies the parking location indicator 126 within the image data. The processor 134 then determines the target position P_{TAR} for parking the host vehicle 102 based on the parking location indicator 126. The processor 134 may define the target position P_{TAR} with reference to a target longitudinal axis X1_{TAR}. The processor 34 then generates the parking assist signal S1.

The guidance module 136C operates to determine the target route R between the current position P_{CUR} of the host vehicle 102 and the target position P_{TAR}. The guidance module 136C implements a geometric algorithm to generate the target route R. The guidance module 136C may, for example, utilise the angular offset between the current vehicle longitudinal axis X1 and the target longitudinal axis X1_{TAR}; and the lateral offset between the current position P_{CUR} of the host vehicle 102 and the target position P_{TAR}.

The parking assist controller 104 attempts to identify the presence of any obstructions along the target route R. Typical obstructions include kerbs, walls, vehicles, etc. The parking assist controller 104 can optionally also determine terrain features. The terrain features may comprise one or more of the following set: an incline or gradient of the surface; surface roughness, for example to differentiate between a smooth surface and a rough or uneven surface. As described herein, the obstructions may be identified by the obstacle detection module 136D. The guidance module 136C modifies the target route R to avoid any obstructions identified by the obstacle detection module 136D.

In use, a parking control signal S1 is output by the guidance module 136C to the EPAS 18 to adjust the steering angle θ to control the host vehicle 102 to match the actual travel direction of the host vehicle 102 with the target travel direction. The controller HMI 137 can optionally output instructions to prompt the user to select the appropriate drive gear and to operate the vehicle brakes and throttle. The EPAS 118, in dependence on the parking control signal S1 output from the guidance module 136C, steers the host vehicle 102 to follow the target route R. A notification can be output by the controller HMI 137 to notify the user when the host vehicle 102 is in the target position P_{TAR}. The parking assist controller 104 can thereby facilitate reversing the host vehicle 102 to the target position P_{TAR}.

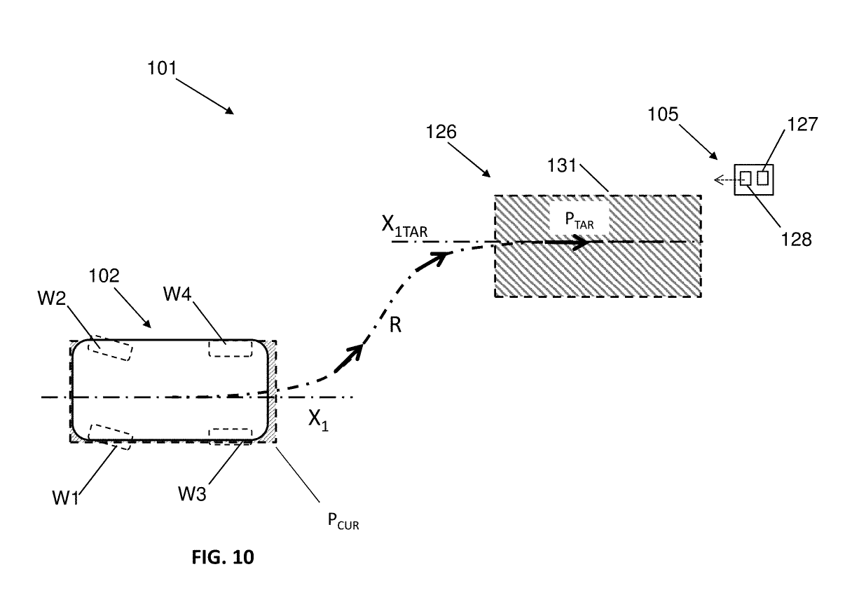

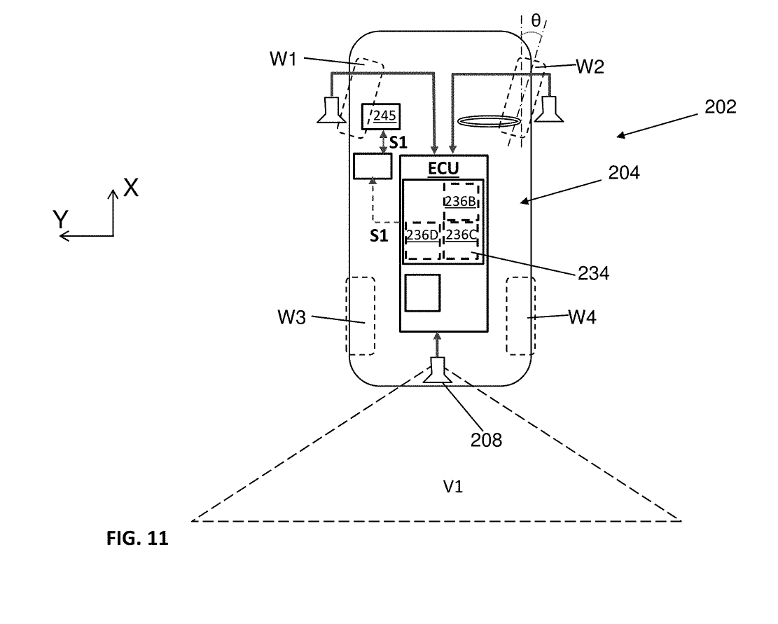

A parking assist system 201 in accordance with a further embodiment of the present invention will now be described with reference to FIGS. 11 and 12. This embodiment is a development of the embodiment described herein with reference to FIGS. 1 to 7. Like reference numerals are used for like components, albeit incremented by 200 to aid comprehension.

The parking assist controller 204 in accordance with the present embodiment is configured to transmit the parking control signal S1 to control a remote vehicle 250. The remote vehicle 250 in this variant is a self-propelling vehicle, for example comprising one or more torque generating machines for outputting a traction force. The parking assist controller 204 is installed in the host vehicle 202 and is configured to identify the parking location indicator 226 generated by the parking beacon 205 in order to determine the target position P_{TAR}. The host vehicle 202 comprises a first transceiver 245 for communicating with the remote vehicle 250. In particular, the parking assist controller 204 is configured to activate the first transceiver 245 to transmit the parking control signal S1 wirelessly to the remote vehicle 3, for example using a suitable wireless communication protocol. The host vehicle 202 may thereby directly or indirectly control operation of the remote vehicle 250. At least in certain embodiments, the host vehicle 202 may operate in a “master” capacity and the separate vehicle 250 in a “slave” capacity. This embodiment of the present invention will now be described in more detail with reference to FIG. 12. Like reference numerals are used for like components.

As illustrated in FIG. 12, the remote vehicle 250 comprises a self-propelling (or active) trailer. The remote vehicle 250 in the present embodiment comprises first and second torque generating machines 251, 252 arranged to drive respective left and right wheels TW1, TW2 respectively. The first and second torque generating machines 251, 252 each comprise an electric traction machine and a power inverter connected to an on-board traction battery (not shown) or other energy storage means. An electronic control unit (ECU) 253 is provided to control operation of the first and second torque generating machines 251, 252. By controlling the relative speed of said first and second torque generating machines 251, 252, the ECU 253 can control the remote vehicle 250 forwards and backwards, either in a straight line or in a turning motion (proving the remote vehicle 250 with so-called tank controls). The ECU 253 is connected to a second transceiver 254 for communication wirelessly with the host vehicle 202. In use, the remote vehicle 250 may be configured to be towed behind the host vehicle 202. However, to facilitate parking of the remote vehicle 250 and/or coupling of the remote vehicle 250 to the host vehicle 202, the remote vehicle 250 may propel itself independently of the host vehicle 202. The host vehicle 202 and the remote vehicle 250 may communicate with each other, for example using a suitable wireless communication protocol.

In the present embodiment, the parking assist controller 204 is incorporated into the host vehicle 202. As illustrated in FIG. 11, the host vehicle 202 comprises at least one host vehicle camera 208 configured to transmit image data to the parking assist controller 204. The image data from the at least one host vehicle camera 208 may be supplemented with image data from one or more cameras (not shown) disposed on the remote vehicle 250. The remote vehicle 250 may comprise additional sensors, for example proximity sensors which output data to the ECU 253. The parking assist controller 204 comprises a processor 234 configured to implement an image processing module 236B. The image processing module 236B analyses the image data from the host vehicle camera 208 to identify the parking location indicator 226 generated by the parking beacon 205. The operation of the image processing module 236B is the same as described herein with respect to the previous embodiment(s). The processor 234 determines the target position P_{TAR} for parking the remote vehicle 250 based on the parking location indicator 126. The processor 234 may define the target position P_{TAR} with reference to a target longitudinal axis X1_{TAR}.

The processor 234 provided on the host vehicle 202 comprises a guidance module 236C which determines the target route R between the current position P_{CUR} of the remote vehicle 250 and the target position P_{TAR}. The guidance module 236C implements a geometric algorithm to generate the target route R. The guidance module 236C may, for example, utilise the angular offset between the longitudinal axis X2 of the remote vehicle 250 and the target longitudinal axis X1_{TAR}; and the lateral offset between the current position P_{CUR} of the remote vehicle 250 and the target position P_{TAR}.

The parking assist controller 204 may optionally also attempt to identify the presence of any obstacles along the target route R. Typical obstacles include kerbs, walls, vehicles, etc. The parking assist controller 204 can optionally also determine terrain features. The terrain features may comprise one or more of the following set: an incline or gradient of the surface; surface roughness, for example to differentiate between a smooth surface and a rough or uneven surface. As described herein, the obstructions may be identified by the obstacle detection module 236D. The guidance module 236C modifies the target route R to avoid any obstacles identified by the third image processing module 236D.

In use, the guidance module 236C transmits the parking control signal S1, via the first transceiver 245, to the remote vehicle 250. The ECU 253 controls steering of the remote vehicle 250 in dependence on the received the parking control signal S1. As illustrated in FIG. 12, the ECU 253 controls the remote vehicle 250 to follow the target route R. A notification may be output to notify the user when the remote vehicle 250 is in the target position P_{TAR}. The parking assist controller 204 can thereby facilitate reversing the self-propelled trailer 250 to the target position P_{TAR}.

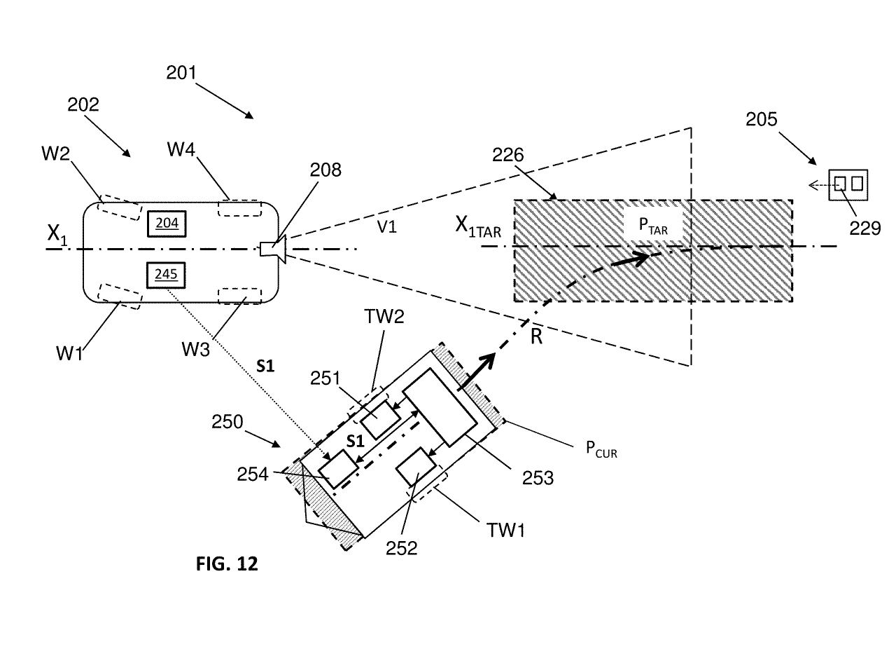

The operation of the parking assist controller 204 to control the remote vehicle 250 is illustrated with reference to a block diagram 73 shown in FIG. 13. The processor 234 determines the current position P_{CUR} of the remote vehicle 250 (BLOCK D1). The processor 234 may, for example, analyse image data from the host vehicle camera 208 provided on the vehicle 202 to identify the current position P_{CUR} of the remote vehicle 250. Alternatively, or in addition, the vehicle 202 may determine the current position P_{CUR} using triangulation techniques, for example by measuring a time-of-flight of wireless signals transmitted to or from the remote vehicle 250. The processor 234 receives image data from the host vehicle camera 208 (BLOCK D2); and identifies the parking location indicator 226 (BLOCK D3). The guidance module 236C determines the target route R from the current position P_{CUR} of the remote vehicle 250 to the target position P_{TAR} (BLOCK D5). The processor 234 identifies obstacles along the target route R (BLOCK D6). The third image processing module 36D may optionally receive additional image data from one or more cameras provided on the host vehicle 202 and/or the remote vehicle 250 (BLOCK D7). If required, the guidance module 36C may modify the target route R to avoid any identified obstacles (BLOCK D8). It will be understood that any obstacles may be identified prior to generation of the target route R. The processor 234 generates the parking assist signal S1 (BLOCK D9). The parking assist signal S1 is transmitted to the remote vehicle 250, for example as a wireless signal (BLOCK B10).

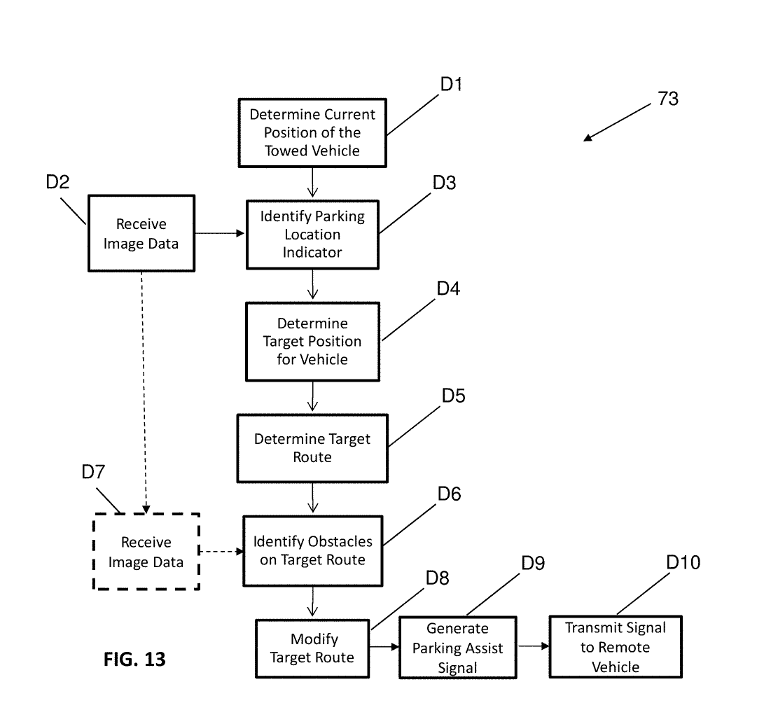

A parking assist system 301 in accordance with a further embodiment of a parking beacon 305 in accordance with an aspect of the present invention will now be described with reference to FIGS. 14 to 18. The parking beacon is a development of the embodiment illustrated in FIG. 3. Like reference numerals are used for like components, albeit incremented by 300 to aid comprehension. The parking beacon 305 is described with reference to a parking assist controller 304 disposed in a towing vehicle 302 coupled to a towed vehicle 303, but it will be understood that the parking beacon 305 may be used in the other embodiments described herein.

As shown in FIG. 14, the parking beacon 305 comprises a beacon control unit 327 and at least a first projection system 328 for projecting a parking location indicator 326. The first projection system 328 in the present embodiment comprises a light source 329; and a controllable optical guide means 330. The optical guide means 330 is configured to define a light path 331 for the light emitted from the light source 329. The optical guide means 330 in the present embodiment comprises a mirror 330. The light source 329 in the present embodiment comprises a laser diode for emitting a laser. The light source 329 is configured to emit a beam of light along the light path 331 to generate the parking location indicator 326. The beam of light is incident on the ground and provides a visual representation of a position and/or an orientation and/or a profile of the target position P_{TAR}. The parking beacon 305 also comprises a beacon human machine interface (HMI) 332 for controlling operation of the parking beacon 305.

The light source 329 comprises a laser diode. The mirror 330 is an optical mirror configured to reflect the light emitted from the light source 329. The mirror 330 is a scanning mirror and the orientation of the mirror 330 is adjustable dynamically to modulate the emitted light. The mirror 330 may, for example, comprise a micro-opto-electromechanical system (MOEMS). The mirror 330 in the present embodiment is pivotable about a first pivot axis X1 and a second pivot axis Z1. The first and second pivot axes X1, Z1 are disposed substantially perpendicular to each other. The mirror 330 is pivotable about said first and second axes X1, Z1 to adjust the direction of the light path 331. The beacon control unit 327 is configured to control the orientation of the mirror 330 to trace the profile of the parking location indicator 326. The beacon control unit 327 controls the mirror 330 to project the light onto the ground so that the parking location indicator 326 is visible. The beacon control unit 327 may selectively energize and de-energize the light source 329 to generate a continuous or interrupted trace. The parking location indicator 326 in the present embodiment comprises a rectangular frame corresponding to an outer perimeter of the target position P_{TAR}.

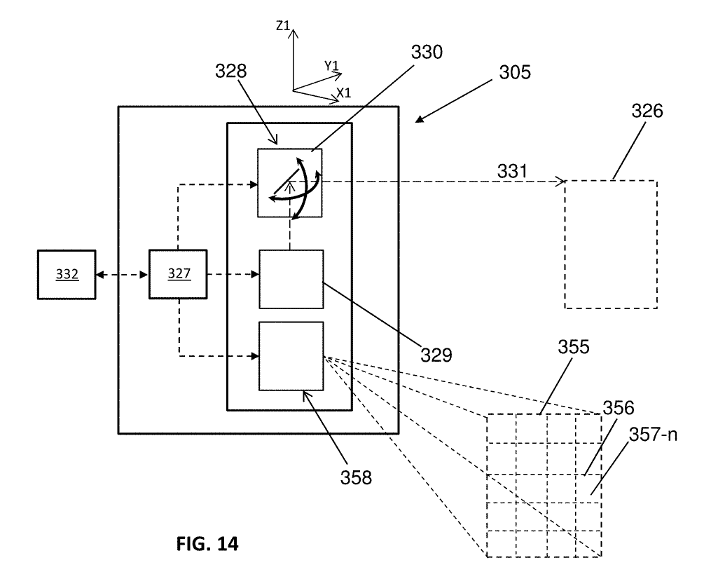

The beacon control unit 327 is configured to control the energization of the light source 329 and the orientation of the mirror 330 to form the parking location indicator 326. By changing the orientation of the mirror 330, the light emitted by the light source 329 traces the parking location indicator 326 onto the ground, as illustrated in FIG. 15. The resulting parking location indicator 326 is detectable by the parking assist controller 304 and may also provide a transient visual representation of the target position P_{TAR}. The direction of the light path 331 may be controlled to define one or more sides of the target position P_{TAR}.

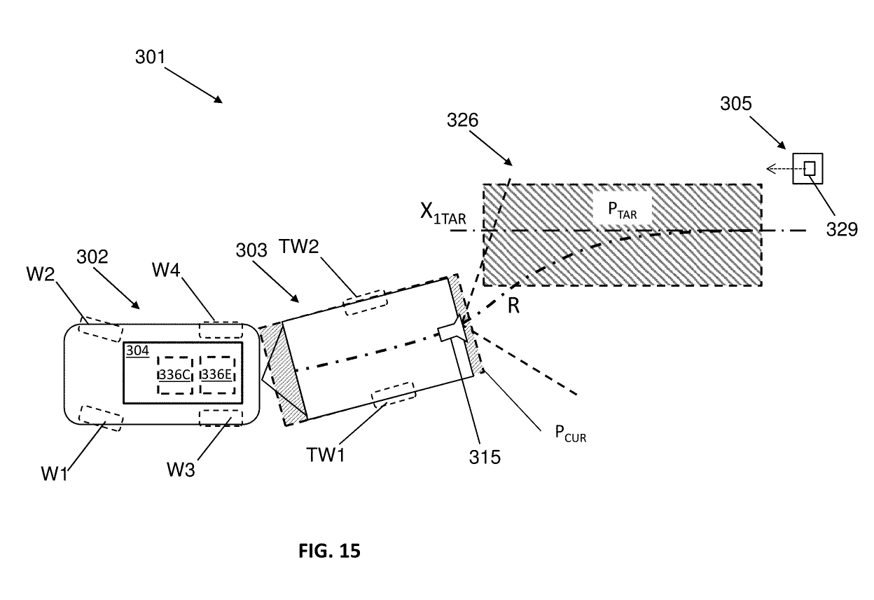

As illustrated in FIGS. 16A and 16B, the parking beacon 305 in the present embodiment is configured also to project a terrain reference pattern 355 onto the ground to enable the parking assist controller 304 to assess one or more terrain features. For example, the parking assist controller 304 may assess local changes in a gradient or incline of the target position P_{TAR}. The terrain reference pattern 355 comprises a mesh 356 composed of a plurality of rectangles 357-n having predetermined dimensions. The rectangles 357-n in the present embodiment are all substantially the same size. In a variant, the rectangles 357-n within the terrain reference pattern 355 may have different sizes, for example to facilitate determination of the orientation of the parking location indicator 326. The terrain reference pattern 355 could be generated by the light source 329. However, as illustrated in FIG. 14, the terrain reference pattern 355 in the present embodiment is generated by a second projection system 358 provided in the parking beacon 305. The second projection system 358 is configured to project the terrain reference pattern 355 onto the ground. When projected onto the ground, the profile of the terrain reference pattern 355 is distorted by features and/or characteristics of the terrain. The distortion may, for example, comprise a deviation from an expected line shape, typically a straight line, and convert deviations into a contour map. The mesh 356 functions as a gradient (contour) mesh to enable determination of the terrain feature(s) and/or characteristic(s). It will be understood that the terrain reference pattern 355 may take a different form. For example, the terrain reference pattern 365 may comprise a plurality of regular or irregular geometric shapes, such as lines, curves, polygons (triangles, squares, pentagons, hexagons, etc.), circles or ellipses. The geometric shapes may have predetermined dimensions and may be arranged in a predetermined configuration, for example at a known distance apart from each other. The geometric shapes may, for example, be arranged in an array having a predetermined spacing therebetween.

As illustrated in FIGS. 16A and 16B, variations in the contours and profile of the ground distort the shape of the terrain reference pattern 355 projected onto the ground. If the terrain reference pattern 355 is projected onto a section of ground which is flat and substantially horizontal, the projected rectangles 357-n closely correlate to the known predetermined pattern. However, the terrain reference pattern 355 may be projected onto a section of ground which is uneven, for example comprising one or more of the following features: an inclined section, a dip or depression, a hump or mound. If the terrain reference pattern 355 is projected onto an uneven section of ground, there is less correlation between the projected rectangles 357-n and the known predetermined pattern. The profile of the terrain reference pattern 355 projected onto the ground is dependent on the profile of the section of ground, as illustrated in FIG. 16B. The spacing between transverse lines making up the terrain reference pattern 355 may increase or decrease depending on the local gradient of the ground. For example, the spacing between adjacent transverse lines will increase in a region where the ground slopes downwardly away from the parking beacon 305; and the spacing between adjacent transverse lines will decrease in a region where the ground slopes upwardly away from the parking beacon 305. An incline from one side to the other (from left to right or from right to left) may have a corresponding effect on the spacing between longitudinal lines making up the terrain reference pattern 355. Alternatively, or in addition, the angular orientation of lines relative to each other within the image data may be used to derive terrain features. For example, adjacent lines which are parallel to each other (or at a known angle relative to each other) within the terrain reference pattern 355 may be distorted by the terrain features and appear inclined at an angle relative to each other within the captured image. A discontinuity or interruption in the terrain reference pattern 355 may indicate the presence of an obstacle, such as a rock or boulder. Similarly, the detection of a plurality of discontinuities or interruptions may indicate that the surface is rough or uneven.

A camera 315 disposed on the towed vehicle 303 is configured to capture image data comprising the projected terrain reference pattern 355. The parking assist controller 304 analyses the image data to determine one or more terrain features. In particular, the parking assist controller 304 is configured to analyse the image data to determine an incline of the terrain within the target position P_{TAR}. As illustrated in FIG. 15, the parking assist controller 304 in the present embodiment comprises a terrain modelling module 336E. The terrain modelling module 336E is configured to compare a stored (reference) image of the terrain reference pattern 355 with an actual image of the projected terrain reference pattern 355, as captured by the camera 315. The terrain modelling module 336E detects variations between the stored (reference) image of the terrain reference pattern 355 and the actual image captured by the camera 315 to determine the local terrain characteristics.

It will be appreciated that the profile of the rectangles 357-n is also dependent on the relative position of the camera 315. As the towed vehicle 303 approaches the target position P_{TAR}, the shape of the rectangles 357-n may change. The terrain modelling module 336E may be configured to apply corrections to the image data to allow for any such changes in perspective. The terrain modelling module 336E may, for example, detect the beacon 305 within the image data. The dimensions of the beacon 305 can be predefined and may be used to calibrate the image data, for example by calculating a distance between the camera 315 and the terrain reference pattern 355. In the arrangement illustrated in FIG. 12, the host vehicle 202 remains stationary and it is not necessary to apply corrections to account for the change in perspective.

Rather than apply a correction to the image captured by the camera 315 disposed on the towed vehicle 303, the parking beacon 305 may be provided with one or more imaging sensors, such as a camera (not shown), for capturing an image. The imaging sensor(s) may capture light in the visible spectrum or outside the visible spectrum, for example infrared or ultraviolet (UV) light. The camera provided on the parking beacon 305 should be offset from the axis of the second projection system 358, for example in a vertical direction, to facilitate detection of distortions in the projected image. The imaging sensor(s) provided on the parking beacon 305 may be configured to capture an actual image of the projected terrain reference pattern 355. The parking beacon 305 may comprise a transmitter configured to transmit the image data to the parking assist controller 304 for analysis by the terrain modelling module 336E. The parking assist controller 304 may compare the captured image data with the stored (reference) terrain reference pattern 355 to determine the terrain features. It will be understood that the perspective of the terrain reference pattern 355 would not change as the location of the imaging sensor(s) remains at least substantially fixed. In a variant, the terrain modelling module 336E could be incorporated into the parking beacon 305. The terrain modelling module 336E may be configured to compare the terrain reference pattern 355 with an actual image of the projected terrain reference pattern 355 captured by the camera (not shown) provided in the parking beacon 305. In a further variant, the terrain reference pattern 355 could be generated by providing the second projection system 358 on the towing vehicle 302 or the towed vehicle 303. A camera may optionally be provided on the towing vehicle 302 or the towed vehicle 303. The terrain modelling module 336E may operate to determine one or more terrain characteristics in the direction of travel of the towing vehicle 302 or the towed vehicle 303.

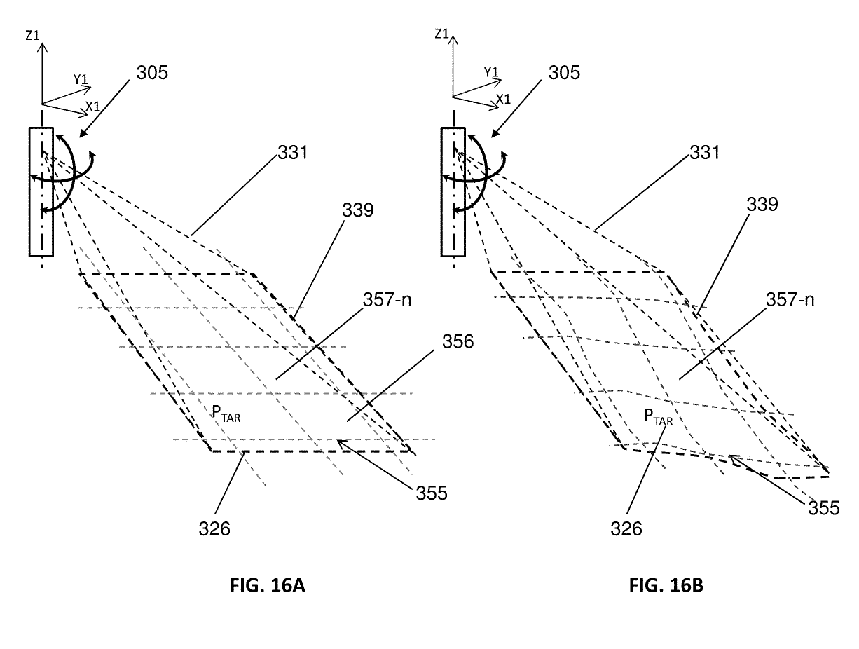

The operation of the parking assist controller 304 and the parking beacon 305 to identify terrain features in dependence on the projected terrain reference pattern 355 is illustrated in a block diagram 74 shown in FIG. 17. The terrain reference pattern 355 is projected on the ground by the second projection system 358 (BLOCK E1). The camera 315 provided on the towed vehicle 303 captures image data of a scene including at least a portion of the projected terrain reference pattern 355 (BLOCK E2). The terrain modelling module 336E analyses the captured image data (BLOCK E3); and identifies an incident pattern corresponding to the projected terrain reference pattern 355 (BLOCK E4). The terrain modelling module 336E compares the incident pattern to the predefined terrain reference pattern 355 and identifies distortions therein (BLOCK E5). The terrain modelling module 336E analyses the distortions to identify one or more terrain features (BLOCK E6). The terrain modelling module 336E may generate a map of the identified terrain features.

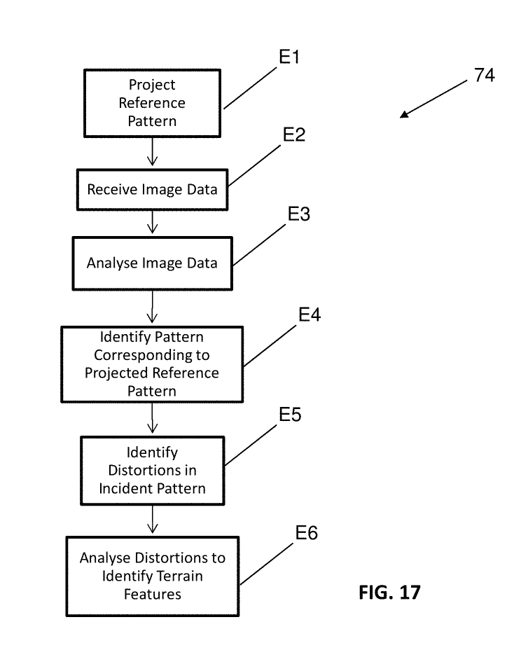

The terrain reference pattern 355 may at least substantially correspond to the dimensions of the parking location indicator 326, for example to identify terrain features in the target position P_{TAR}. Alternatively, the terrain reference pattern 355 may be smaller than the dimensions of the parking location indicator 326, for example to identify terrain features in one or more regions of the target position P_{TAR}. The terrain reference pattern 355 in the present embodiment is larger than the parking location indicator 326. This arrangement enables determination of one or more terrain characteristics on at least one side of the parking location indicator 326. As illustrated in FIG. 18, the terrain reference pattern 355 may extend at least partway between the target position P_{TAR} and a current position P_{CUR} of the towed vehicle 303 (or the towing vehicle 302). In a variant of the present embodiment, the terrain modelling module 336E is configured to identify one or more terrain features along at least a portion of the target route R between the target position P_{TAR} and the current position P_{CUR} of the towed vehicle 303. The terrain modelling module 336E receives image data comprising the projected terrain reference pattern 355. The terrain modelling module 336E processes the image data to detect changes in the incline along the target route R. The terrain modelling module 336E may determine an incline angle; and/or an incline direction of the incline.

By identifying terrain features along the target route R, a feed forward loop can be established to enable vehicle systems to anticipate associated dynamic changes as the towing vehicle 302 and/or the towed vehicle 303 progress along the target route R. For example, the identified terrain features can be used to predict instances where the path followed by the towing vehicle 302 and/or towed vehicle 303 may deviate from an expected path, for example due to side-slip when travelling over a surface having a low coefficient of friction, such as wet grass. By pre-emptively identifying terrain features which may cause this type of behaviour, the guidance module 336C may compensate when generating the target route R. In the scenario where the towed vehicle 303 is being reversed across a side slope, the towed vehicle 303 will tend to slip down the slope. The guidance module 336C may be configured to aim the towed vehicle 303 higher up the incline to correct for this lateral motion. The amount of slip will depend on the surface and also surface conditions, such as how wet the surface is. A variant of the systems described herein may derive surface features or characteristics, for example using an imaging system or wheel slip measurements to differentiate between grass and tarmac. Alternatively, an initial assumption may be made that the surface has a low coefficient of friction and, if this is not the case, applying corrections towards the end of the manoeuvre. Another related example would be if the target location was up an incline, the target route R can be modified to make the trajectory on the slope directly up rather than across by turning more sharply early on.

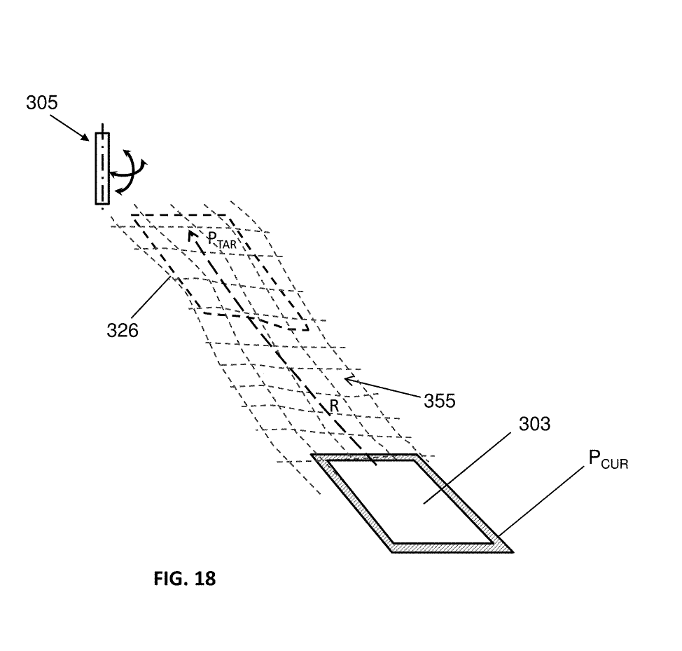

As illustrated in FIG. 19, detected changes in incline along the target route R may be used to estimate the traction torque (Nm) required to propel the towing vehicle 302 and the towed vehicle 303 along the target route R. If, for example, the target route traverses a hollow, the path planning may choose to use a little more momentum or, at least, to be ready to apply more traction torque when required. The terrain modelling module 336E may estimate the required propulsion torque at one or more locations along the target route R, for example to maintain a constant speed. A traction torque profile may be generated for the target route R, as illustrated in FIG. 19. The estimated torque may be output to an engine control unit (not shown) and/or a transmission control unit, to enable one or more vehicle parameters to be configured pre-emptively to output the estimated torque required to propel the towing vehicle 302 and the towed vehicle 303 along said route R. If the estimated incline exceeds a predetermined threshold, the terrain modelling module 336E may provide feedback to the guidance module 336C. By anticipating the traction torque requirements, corrections to the torque may be implemented pre-emptively to allow for anticipated changes as the towing vehicle 302 and/or the towed vehicle 303 traverses the at least one terrain feature. A transmission control signal may be generated to control operation of an automatic or semi-automatic transmission provided in the towing vehicle 302, for example pre-emptively to select an appropriate gear ratio.

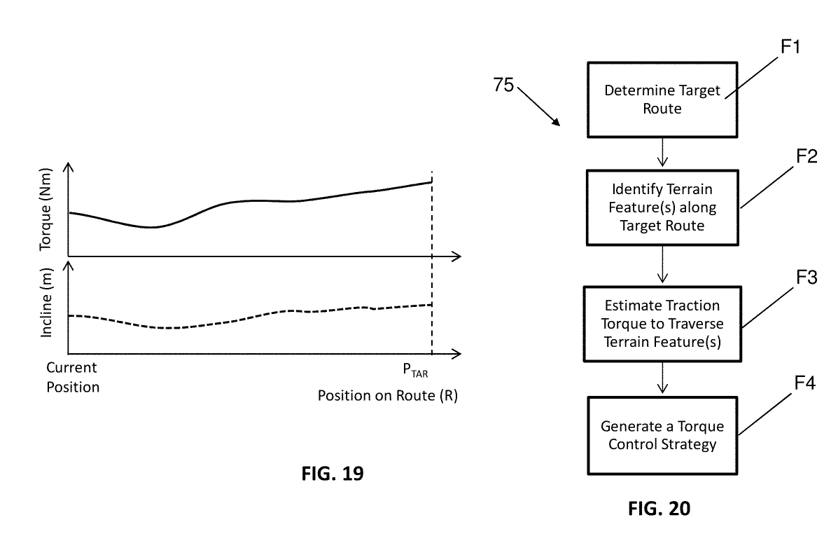

The operation of the parking assist controller 304 pre-emptively to determine traction torque requirements in dependence on the projected terrain reference pattern 355 is illustrated in a block diagram 75 shown in FIG. 20. As described herein, the guidance module 36C determines the target route R from the current position P_{CUR} to the target position P_{TAR} (BLOCK F1). The terrain modelling module 336E identifies one or more terrain features along the target route (BLOCK F2). The terrain modelling module 336E may, for example, determine an incline angle and/or an incline direction on the target route R. In dependence on the terrain feature(s) identified by the terrain modelling module 336E, an estimation is made of the traction torque required to drive the towing vehicle 302 and the towed vehicle 303 along the target route (BLOCK F3). A torque control strategy is generated in dependence on the estimated traction torque (BLOCK F4). The torque control strategy may, for example, comprise a traction torque profile, as illustrated in FIG. 19.

The guidance module 336C may modify the route R in dependence on the identified terrain feature(s). Alternatively, or in addition, the guidance module 336C may calculate the target route R in dependence on the at least one terrain feature identified by the terrain modelling module 336E. The guidance module 336C may, for example, circumnavigate one or more detected terrain features or obstacles. The guidance module 336C may generate the target route R to avoid an incline which exceeds a predetermined incline angle. The guidance module 336C may generate the target route R such that a traversal angle (i.e. the angle at which the target route traverses an incline) reduces a predicted roll angle of the towing vehicle 302 and/or the towed vehicle 303. The term roll angle is used herein to refer to an angle about the longitudinal axis X of the towing vehicle 302 or the towed vehicle 303. Alternatively, or in addition, the guidance module 336C may generate the target route R to ascend or descend an incline to reduce a predicted pitch angle of the towing vehicle 302 and/or the towed vehicle 302. The term roll angle is used herein to refer to an angle about the transverse axis Y of the towing vehicle 302 or the towed vehicle 303. The guidance module 336C may be configured to generate the target route R such that a predicted pitch angle of the towing vehicle 302 and/or the towed vehicle 303 remains below a predetermined pitch angle threshold. Alternatively, or in addition, the guidance module 336C may be configured to generate the target route R such that a predicted roll angle of the towing vehicle 302 and/or the towed vehicle 303 remains below a predetermined roll angle threshold.

The guidance module 336C may generate a steering control signal to steer the towing vehicle 302 along the target route R. The steering control signal may, for example, be output to an electric power assisted steering (EPAS) system. The steering control signal can include a compensatory element at least partially to correct for a predicted direction change as the towing vehicle 302 traverses the at least one terrain feature identified by the guidance module 336C. The compensatory element may at least partially correct for a predicted direction change of the towing vehicle 302, for example a side-slip or lateral movement of the towing vehicle 302 and/or the towed vehicle 303. The compensatory element may therefore correct for an anticipated direction change caused by a turning force generated by the towing vehicle 303 traversing the at least one terrain feature. It will be understood that these control strategies may be implemented to control a host vehicle irrespective of whether a towed vehicle is connected. The control strategies are applicable when travelling in a forwards direction or when reversing.

In a modified arrangement, the terrain reference pattern 355 could also function as the parking location indicator 326. For example, the terrain modelling module 336E could be configured to determine one or more terrain characteristics and also the parking location indicator 326 in dependence on the projected terrain reference pattern 355.

As described herein, the second projection system 358 is disposed in the parking beacon 305. In a variant, the second projection system 358 may be disposed in the towing vehicle 302 or the towed vehicle 303. The terrain reference pattern 355 could be projected onto the ground in front of the towing vehicle 302 or the towed vehicle 303. The terrain modelling module 336E could thereby identify one or more terrain characteristics or features in front of the towing vehicle 302 or the towed vehicle 303.

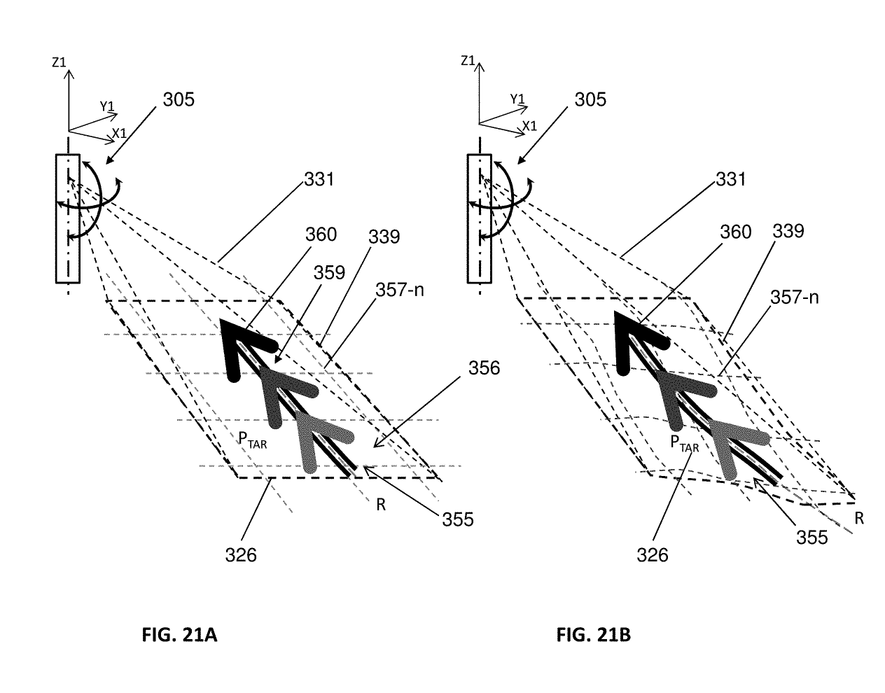

A further embodiment of a parking beacon 305 in accordance with an aspect of the present invention will now be described with reference to FIGS. 21A and 21B. The parking beacon 305 is a development of the embodiment described herein with reference to FIGS. 14 to 17. Like reference numerals are used for like components. The parking beacon 305 is described with reference to a parking assist controller 304 disposed in a towing vehicle 302 coupled to a towed vehicle 303, but it will be understood that the parking beacon 305 may be used in the other embodiments described herein.

The parking beacon 305 is configured to project a graphical representation of at least a portion of the target route R. The target route R is transmitted by the park assist controller 304 disposed in the towing vehicle 302. The beacon control unit 327 receives the target route R and controls the projection system provided in the parking beacon 305 to project a route indicator 359 representing at least a portion of the target route R. The route indicator 359 is projected onto the ground and, at least in certain embodiments, is visible to provide an indication of the current trajectory of the towed vehicle 303. As shown in FIG. 21A, the route indicator 359 in the present embodiment comprises at least one arrow 360, but it will be understood that the route indicator 359 may take different forms.

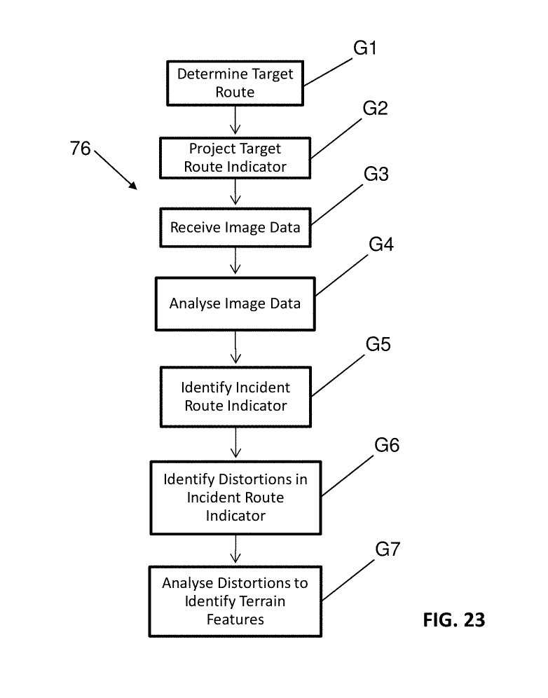

The operation of the parking assist controller 304 and the parking beacon 305 to identify terrain features in dependence on the projected route indicator 359 is illustrated in a block diagram 76 shown in FIG. 23. As described herein, the guidance module 336C determines the target route R from the current position P_{CUR} to the target position P_{TAR} (BLOCK G1). The route indicator 359 is projected on the ground by the first projection system 328 (BLOCK G2). The camera 315 provided on the towed vehicle 303 captures image data of a scene including at least a portion of the projected route indicator 359 (BLOCK G3). The terrain modelling module 336E analyses the captured image data (BLOCK G4); and identifies an incident pattern corresponding to the projected route indicator 359 (BLOCK G5). The terrain modelling module 336E compares the incident route indicator to an image corresponding to the projected target route R and identifies distortions in the incident route indicator (BLOCK G6). The terrain modelling module 336E analyses the distortions to identify one or more terrain features (BLOCK G7). The terrain modelling module 336E may generate a map of the identified terrain features.

It has been recognised that projecting a visible warning indicator representing a current or predicted trajectory of the towing vehicle 302 and/or the towed vehicle 303 may prove useful for a person (or persons) external to the vehicle. The visible warning indicator may comprise or consist of a trajectory indicator. For example, the visible warning indicator may allow a third party to determine an expected route along which the towing vehicle 302 and/or the towed vehicle 303 will travel. The projection system described herein would be suitable for generating and projecting the visible warning indicator. The projection system could be provided in the parking beacon 305. Alternatively, or in addition, the projection system may be installed in the towing vehicle 302 and/or the towed vehicle 303. It will be understood that the projection system would be operable independently of other external lighting systems, such as the headlamps. The visible warning indicator may comprise or consist of a direction marker, such as an arrow, or other indicia suitable for representing the vehicle trajectory. It is envisaged that the visible warning indicator would be provided onto the ground proximal to the vehicle. For example, the visible warning indicator may be projected onto the ground in front of or behind the vehicle depending on the direction of travel. The visible warning indicator may be projected behind the vehicle during a reversing manoeuvre. The visible warning indicator may be generated in dependence on a steering angle and/or a target route R. The visible warning indicator may also comprise a vehicle speed indicator.

The parking assist controller 304 in this embodiment may determine an expected profile of the route indicator 359 in dependence on the target route R. However, the profile of the route indicator 359 when projected varies depending on the profile of the ground. By way of example, the route indicator 359 is illustrated as being projected onto an even, substantially horizontal surface in FIG. 21A. However, if the same route indicator 359 is projected onto an uneven surface, the projection is distorted in dependence on the terrain characteristics. In accordance with an aspect of the present invention, the parking assist controller 304 is configured to compare an actual image captured by the camera 315 provided on the towed vehicle 303 with an expected profile of the route indicator 359 determined in dependence on the determined target route R. By way of example, the route indicator 359 is illustrated in FIG. 21B projected onto an uneven surface comprising an inclined region. The parking assist controller 304 may be configured to determine one or more terrain features in dependence on the distortion of the route indicator 359. For example, the parking assist controller 304 may determine an incline or gradient of the surface or detect one or more obstacles along the target route R. It will be understood that this technique may be used in conjunction with the other techniques described herein, for example the projection of the terrain reference pattern 355 described with reference to FIGS. 14 to 16.

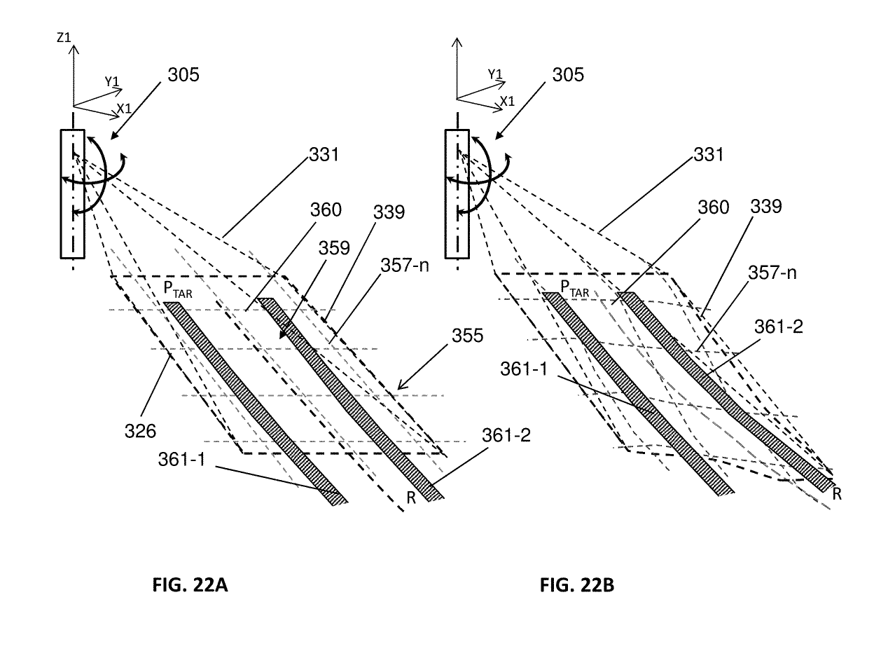

A variant of the parking beacon 305 described herein with reference to FIGS. 21A and 21B is shown in FIGS. 22A and 22B. In this variant, the route indicator 359 comprises first and second path lines 361-1, 361-2 representing the target route R of the vehicle. The first and second path lines 361-1, 361-2 in the present embodiment correspond to a predicted path of the respective first and second trailer wheels TW1, TW2. At least in certain embodiments, projecting the path lines 361 may facilitate identification of obstacles directly in the path of the trailer wheels TW1, TW2 as it travels along the target route R.

The parking assist controller 304 may be configured to compare an actual image captured by the camera 315 provided on the towed vehicle 303 with an expected profile of the first and second path lines 361-1, 361-2 determined in dependence on the determined target route R. With reference to FIG. 22B, the first and second path lines 361-1, 361-2 are projected onto an uneven surface comprising an inclined region. The parking assist controller 304 may be configured to determine one or more terrain features in dependence on the distortion of the first and second path lines 361-1, 361-2. For example, the parking assist controller 304 may determine an incline or gradient of the surface or detect one or more obstacles present along the target route R. Alternatively, or in addition, the parking assist controller 304 may determine one or more terrain features by comparing the first and second path lines 361-1, 361-2. For example, the trajectory of the first and second path lines 361-1, 361-2 may be compared to determine gradient changes. If the first and second path lines 361-1, 361-2 are not parallel when projected onto the ground, the parking assist controller 304 may determine that there is a slope or gradient. It will be understood that the parking assist controller 304 may be provided in the towing vehicle 302 or the parking beacon 305.

The towed vehicle 303 may be subject to lateral movements, such as side slipping, depending on terrain features. These lateral movements may, for example, result from the towed vehicle 303 traversing an uneven or sloping surface. The parking assist controller 304 may be configured to modify the target route R in dependence on detected terrain features, such as a detected gradient or slope. The parking assist controller 304 may determine the target route R to steer the towed vehicle 303 up an incline or slope to counteract side slip. The parking assist controller 304 may determine the target route R so as to avoid holes. If the target route R cannot avoid a hole or an uneven surface, the parking assist controller 304 may be configured to counteract a turning moment of the towed vehicle 303 as a trailer wheel TW1, TW2 traverses the hole or the uneven surface. The parking assist controller 304 may be configured to modify the target route R in dependence on detected gradient changes. For example, the parking assist controller 304 may modify the target route R to ensure that the gradient in a transverse direction and/or a longitudinal direction is below a predetermined gradient threshold. Alternatively, or in addition, the parking assist controller 304 may modify the parking assist signal S1 to compensate for changes in the trajectory of the towed vehicle 303 resulting from gradient changes. For example, the parking assist signal S1 may be modified to compensate for changes in the gradient under the first and second trailer wheels TW1, TW2. The target route R could be determined to compensate for side-slip, for example when traversing an inclined surface. The parking assist controller 304 may, for example, determine the target route R so as to steer up a slope to counteract side slip.

At least some of the embodiments described herein propose that the parking assist controller for generating the target route R is provided in the towing vehicle. However, at least in certain embodiments, the parking assist controller may be provided in the parking beacon. This implementation has the advantage that the parking assist system can more readily be retrofitted, for example for use with any vehicle which is self-propelling. In the case of a self-propelling trailer, a wireless camera may be mounted to the trailer to determine an angular orientation in relation to the beacon. A remote control may be incorporated into the parking beacon for controlling the trailer. Alternatively, or in addition, a beacon camera can be provided to identify the trailer and to determine its relative position and/or orientation. It will be understood that these control strategies may also be used to control a towing vehicle.

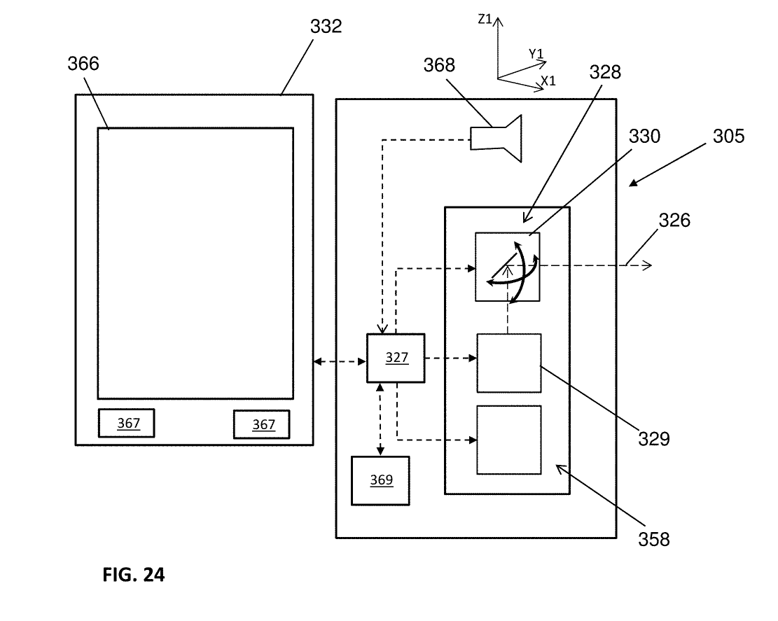

A schematic representation of the parking beacon 305 in accordance with a further aspect of the present invention is shown in FIG. 24. The beacon HMI 332 comprises a display screen 366, a user input means 367, a beacon camera 368 and a transceiver 369. The user input means 367 comprises one or more control devices, such as a mechanical switch, a button, a knob, a capacitive switch or a resistive switch. Alternatively, or in addition, the user input means 367 may be combined with the display screen 366, for example in the form of a touch-sensitive display. The beacon control unit 327 comprises an image processor for processing the image data captured by the beacon camera 368 to determine the relative position and/or orientation of the towed vehicle 303. The beacon control unit 327 is configured to output image data captured by the beacon camera 368 to the display screen 366. The beacon control unit 327 is configured to augment the image data from the beacon camera 368 with a parking location indicator 326 and optionally also a graphical representation of a target route R. The resulting augmented image may help a user to visualise the target route R and/or the parking location indicator 326. The user input means 367 may be operable to adjust the position of the parking location indicator 326 and/or to adjust the target route R. Thus, the beacon HMI 332 is configured to generate an augmented image which can be manipulated by a user to modify the target route R. Alternatively, or in addition, the position and/or orientation of the parking location indicator 326 may be manipulated by the user. The target route R and the parking location indicator 326 may be displayed as an overlay on the display image output to the display screen 366. The user validates the inputs when the desired the parking location indicator 326 has been entered. Alternatively, or in addition, the control functions of the beacon HMI 332 may be provided in a controller HMI provided in the towing vehicle 302.

The parking assist controller 304 is configured to generate the target route R in dependence on the determined position and/or orientation of the towed vehicle 303. The parking beacon 305 may optionally communicate with the towing vehicle 302 via the transceiver 369, for example to output the parking assist signal S1. By correlating changes in the orientation of the towed vehicle 303 (which may be determined using the aforementioned image processing techniques) with a known steering angle of the towing vehicle 302, the beacon control unit 327 may optionally determine the relative orientation of the towing vehicle 302 using reverse kinematics. The parking assist controller 304 may be provided in the towing vehicle 302. Alternatively, the parking assist controller 304 may be provided in the parking beacon 305, for example integrated into the beacon control unit 327. The beacon control unit 327 is configured to output the parking assist signal S1 to the transceiver 369 for wireless transmission to the towing vehicle 302.

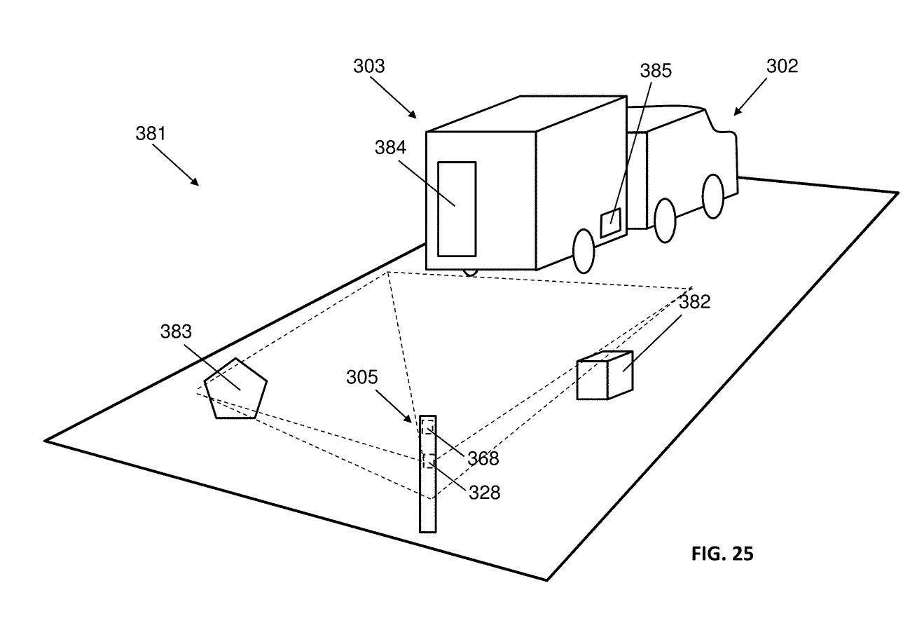

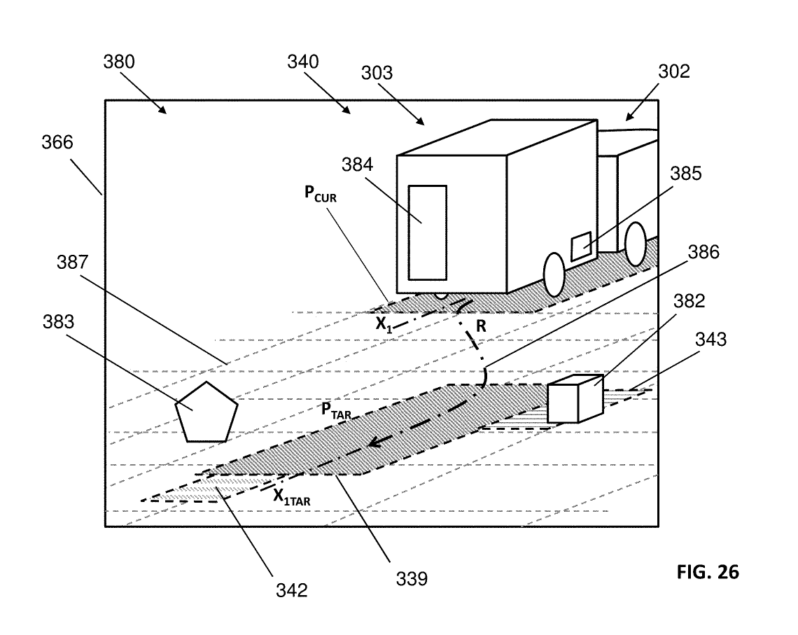

The operation of the beacon control unit 327 to generate an augmented image 380 for output to the display screen 366 will now be described with reference to the FIGS. 25, 26 and 27. A typical parking scenario is represented by way of example in a scene 381 in FIG. 25. The towing vehicle 302 and the towed vehicle 303 are positioned proximal to a desired parking location. In the illustrated example, the towed vehicle 303 is to be parked next to a mains electrical connection 382 whilst avoiding an obstacle 383. The mains electrical connection 382 and the obstacle 383 are both in a fixed location. The parking beacon 305 is positioned by the user on the ground proximal to the desired parking location. The parking beacon 305 is oriented such that the beacon camera 368 is directed towards the desired parking location and preferably also the towed vehicle 303. The resulting image data captured by the beacon camera 368 represents the scene 381, including the towed vehicle 303, the mains electrical connection 382 and the obstacle 383. The image data is output to the display screen 366 and displayed as an image 340, as illustrated in FIG. 26. If necessary, the user may adjust the orientation of the parking beacon 305 such that the beacon camera 368 captures the desired scene elements, such as the desired parking location.

In accordance with an aspect of the present invention, the parking assist controller 304 is configured to augment the image data generated by the beacon camera 368. In particular, the parking assist controller 304 is configured to overlay graphics and information onto the image 340 to generate the augmented image 380. A first augmented image 380 is shown in FIG. 26 incorporating the image 340 captured by the parking beacon 305 in the scene illustrated in FIG. 25. A target position indicator 339 is overlaid onto the image 340 to provide a graphical representation of the target position P_{TAR} relative to other features of the scene 381. As shown in FIG. 26, the target position indicator 339 is scaled at least substantially to match a footprint of the towed vehicle 303 (and optionally also the towing vehicle 302). In the illustrated example, the target position indicator 339 comprises a rectangle which provides an approximate representation of the external profile of the towed vehicle 303. It will be appreciated that the target position indicator 339 may have a different profile, for example to represent more closely the actual profile of the towed vehicle 303 in plan form. The target position indicator 339 in the present embodiment also comprises a door marker 342 and an electrical connector marker 343. The door marker 342 corresponds to a door 384 provided on the towed vehicle 303; and the electrical connector marker 343 corresponds to an electrical connector 385 provided on the towed vehicle 303.

An initial position of the target position indicator 339 within the image 340 could be determined automatically, for example by analysing the image data output from the beacon camera 368. Alternatively, the user may specify the initial position of the target position P_{TAR}. If required, the user may adjust the position of the target position P_{TAR}. For example, the user may actuate the user input means 367 to change the position and/or orientation of the target position indicator 339 within the augmented image 380. When satisfied that the position and/or orientation of the target position indicator 339 corresponds to the position and/or orientation of the target position P_{TAR}, the user validates the entry.

As illustrated in FIG. 26, the parking assist controller 304 may be configured to identify a current position P_{CUR} of the towed vehicle 303 (and optionally also the towing vehicle 304). The parking assist controller 304 may analyse the image 340 to identify the towed vehicle 303, for example using appropriate image processing techniques. Alternatively, the user may identify the towed vehicle 303 within the image 340. In a first operation, the user may position the target position indicator 339 to identify the current position P_{CUR} (and optionally also a current orientation) of the towed vehicle 303. In a second operation, the user may position the target position indicator 339 to identify the target position P_{TAR} (and optionally also a current orientation) of the towed vehicle 303. Other techniques may be utilised to identify the current position P_{CUR} and the target position P_{TAR} of the towed vehicle 303.

The parking assist controller 304 is configured to calculate the target route R along which the towed vehicle 303 is to travel from the current position P_{CUR} to the target position P_{TAR}. The target route R may be calculated at least substantially in real time. As shown in FIG. 25, a target route indicator 386 is overlaid onto the image 340 to represent the target route R. The target route R may be calculated and displayed at least substantially in real time. This real time display of the target route indicator 386 may help the user to visualise changes to the target route R, for example in dependence on changes in the position and/or orientation of the target position P_{TAR}. Alternatively, the target route R may be calculated and the target route indicator 386 displayed only after the user has validated the target position P_{TAR}. The parking assist controller 304 may enable the user directly to modify the target route R. The user may re-position one or more points on the target route indicator 386. In embodiments in which the user input means 367 comprises a touchscreen, the user may touch and move a point on the target route indicator 386 and/or rotate a direction vector associated with that point. The user validates the target route R which is then relayed to the towing vehicle 302. The towing vehicle 302 is controlled in dependence on the target route R to reverse the towed vehicle 303 along the target route R.

It will be understood that other features may be overlaid onto the image 340 to assist the user. By way of example, a contour mesh 387 may be provided to provide an indication of the contours of the ground. The parking assist controller 304 may process the image data to estimate terrain features, for example to identify an incline or slope. The contour mesh 387 may, for example, represent said terrain feature(s). The contour mesh 387 could be generated in dependence on the projected terrain reference pattern. For example, the incident pattern could projected onto the ground be isolated from the captured image data and used to generate the contour mesh 387. Alternatively, or in addition, the parking assist controller 304 may receive data from sensors provided on the towing vehicle 302 or the parking beacon 305, for example from an inertial measurement unit (IMU) comprising one or more accelerometers and/or gyroscopes.

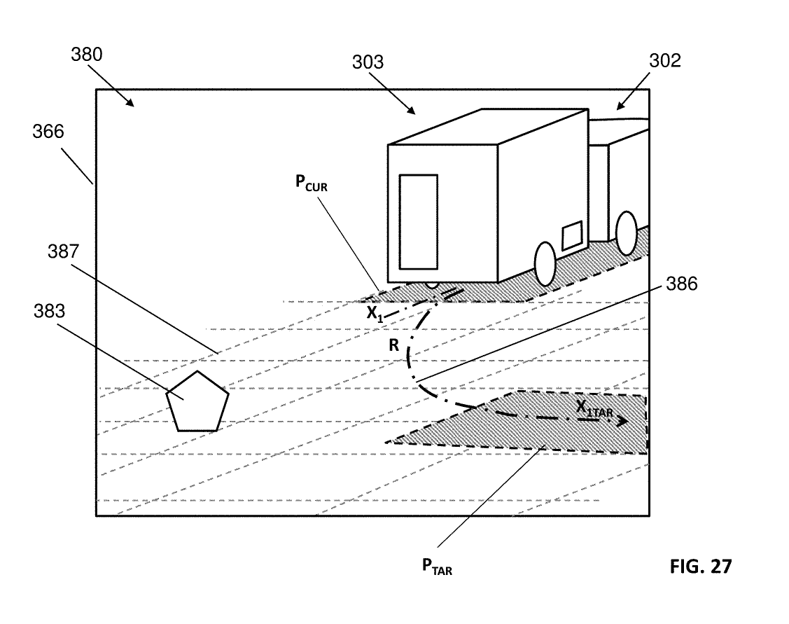

The parking assist controller 304 has been described herein with particular reference to parallel parking of the towed vehicle 302 in which the longitudinal axes X₁, X_{1TAR} of the current position P_{CUR} and the target position P_{TAR} are generally parallel to each other. It will be understood that the parking assist controller 304 in accordance with the present invention is not limited to this mode of operation. By way of example, the parking assist controller 304 can be used when the longitudinal axes X₁, X_{1TAR} of the current position P_{CUR} and the target position P_{TAR} are generally perpendicular to each other, as illustrated in a second augmented image shown in FIG. 27.

In the embodiment described herein with reference to FIGS. 25 to 27, the display screen 366 is provided on the parking beacon 305. The augmented image 380 may be viewed by the user operating the parking beacon 305. It will be understood that the augmented image 380 could be displayed on other display screens. The parking beacon 305 could be configured to transmit the image data corresponding to the augmented image 380 to a receiver. For example, the augmented image 380 could be output to a display screen provided in the towing vehicle 302. Alternatively, or in addition, the augmented image 380 may be output to a general purpose computational device, such as a personal computer (for example a laptop), a tablet computer or a cellular telephone. In a further variant, the augmented image 380 may be generated using image data captured from a camera provided on the computational device. In this variant, it is envisaged that the parking beacon 305 would generate a reference identifier which could be detected by the computational device. The reference identifier could comprise an optical projection, for example an encoded signal. The target route R could be determined by the computational device. Alternatively, the target route R could be transmitted from the parking assist controller 304. Thus, the parking assist controller 304 and the display screen 366 may be provided in separate devices.

The beacon HMI 332 in accordance with the present embodiment may be used in addition to the first projection system 328 described herein. This may, for example, be desirable in bright sunshine where detection of the projected parking location indicator 326 is difficult. Alternatively, the beacon HMI 332 may be used in place of the first projection system 328. In such an arrangement, it will be appreciated that the target route R would not be projected onto the ground. The relative position of towed vehicle 303 and the parking beacon 305 may, for example, be determined using signal triangulation techniques. For example, the transceiver 369 may communicate wirelessly with one or more transceivers provided on the towed vehicle 303 and/or the towing vehicle 302. The time-of-flight of the communications may be used to determine the relative position.

In a variant, the beacon control unit 327 may manipulate the image data captured by the beacon camera 368 to generate a birds-eye view image. The towing vehicle 302 and/or the towed vehicle 303 may optionally also be overlaid onto the image and output to the display screen 366.

The parking beacon described herein is a separate device intended for positioning external to the towing vehicle and the towed vehicle. A user could conceivably forget to retrieve the parking beacon after completing a parking manoeuvre. The parking beacon could be left behind when the towing vehicle and the towed vehicle are driven away.

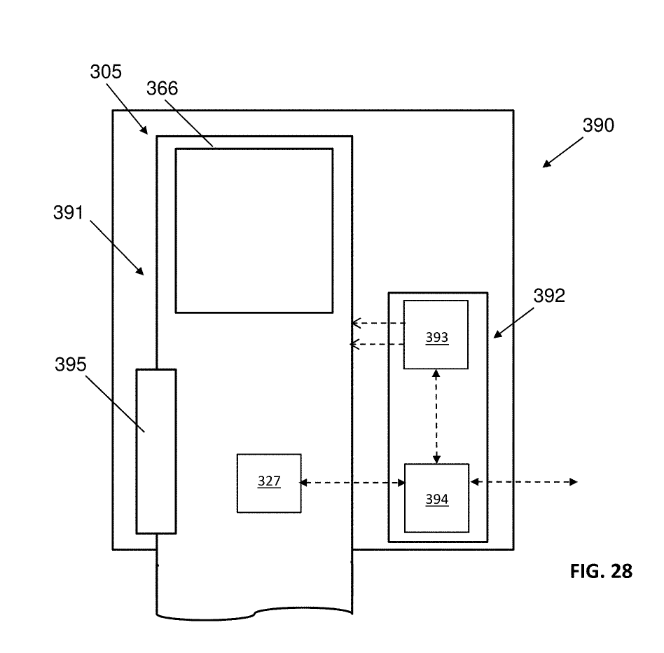

As shown in FIG. 28, the parking assist system 305 may comprise a docking station 390 for docking the parking beacon 305. The docking station 390 is provided in a host vehicle which may be either the towing vehicle 302 or the towed vehicle 303. The docking station 390 comprises a dock 391 for receiving the parking beacon, a dock control unit 392, and a charging unit 393 for charging energy storage means, such as a battery (not shown), provided in the parking beacon 305. The dock 391 is configured to locate the parking beacon 305 in a predetermined position in the docking station 390. The dock 391 may comprise a mechanical retaining mechanism or a magnet for releasably retaining the parking beacon 305. The dock control unit 392 is configured to control operation the charging unit 393 and to communicate with the beacon control unit 327 when the parking beacon 305 is docked. The charging unit 393 comprises a electrical connectors (not shown) for establishing an electrical connection with corresponding electrical connectors provided on the parking beacon 305 when the parking beacon 305 is docked in the docking station 390. The dock control unit 392 comprises an interface 394 for communicating with the beacon control unit 327 when the parking beacon 305 is docked. The interface 394 also communicates with the host vehicle (either the towing vehicle 302 or the towed vehicle 303), for example by connection to a communication bus or network of the host vehicle.

The dock control unit 392 is configured to determine when the parking beacon 305 is docked and when the parking beacon 305 is undocked. The determination may, for example, be made in dependence on the status of a communication link established between the interface 394 and the beacon control unit 327. If the dock control unit 392 cannot establish communication with the beacon control unit 327, the dock control unit 392 determines that the parking beacon 305 is undocked. If the dock control unit 392 can establish communication with the beacon control unit 327, the dock control unit 392 determines that the parking beacon 305 is docked. Alternatively, or in addition, the dock control unit 392 may determine when the parking beacon 305 is docked or undocked by monitoring the status of the charging unit 393. For example, the dock control unit 392 may measure an electrical load across the charging unit 393 to determine when the parking beacon 305 is docked or undocked.

The dock control unit 392 is configured to generate an alert if the parking beacon 305 is undocked and a determination is made that the host vehicle is moving. The dock control unit 392 may, for example, communicate with the host vehicle to determine a vehicle reference speed or a parking brake status. If the vehicle reference speed exceeds a predetermined threshold or the parking brake is released while the parking beacon 305 is undocked, the dock control unit 392 generates an alert. Alternatively, or in addition, wireless communication between the dock control unit 392 and the parking beacon 305 may determine a separation distance. If the separation distance exceeds a predetermined threshold, the dock control unit 392 may generate an alert. The alert may, for example, be output from the dock control unit 392 to the host vehicle and output by the vehicle HMI. Thus, a user may be notified that the parking beacon 305 is not in the host vehicle.

In a further variant, the docking station 390 may comprise a locking mechanism 395 for engaging the parking beacon 305. The locking mechanism 395 may comprise a locking member for engaging a cooperating surface on the parking beacon 305. The locking mechanism 395 may to operable to prevent removal of the parking beacon 305. The locking mechanism 395 may be unlocked using a mechanical key. Alternatively, the locking mechanism 395 may be released using a digital key, for example to deactivate an electromagnetic lock.

It will be understood that the docking station 390 may be incorporated into the host vehicle during manufacture. Alternatively, the docking station 390 may be retrofitted to the host vehicle, for example by connecting to an on-board electrical supply and optionally also the communication network or bus.

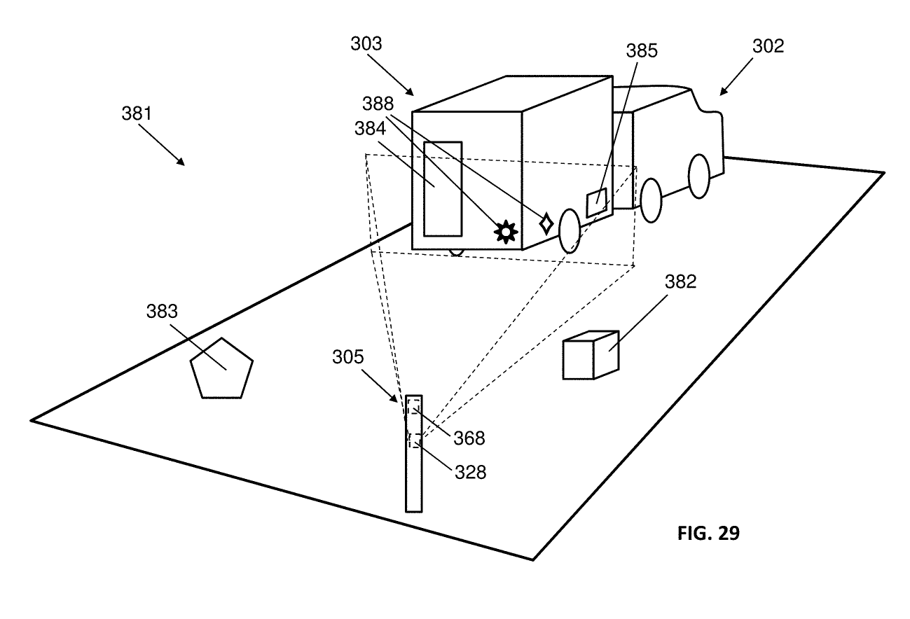

A variant of the parking assist system 301 described herein with reference to FIGS. 14 to 28 will now be described with reference to FIG. 29. Like reference numerals are used for like components.

The parking assist system 301 utilises image processing techniques to identify the towed vehicle 303 in the image data captured by the beacon camera 368. To facilitate robust identification of the towed vehicle 303, at least one target 388 may be provided on the towed vehicle 303. At least in certain embodiments, the at least one target 388 is identifiable using image processing techniques. The at least one target 388 is configured to generate a unique pattern identifiable by analysing the image data captured by the beacon camera 368 (to differentiate from possible specular reflections) to enable determination of the polar location of the towed vehicle 303 relative to the beacon 305.

The at least one target 388 may, for example, be provided on a rearward-facing (back) surface of the towed vehicle 303. Alternatively, or in addition, a target may be provided on one or both opposing sides of the towed vehicle 303. The configuration of the at least one target 388 may be different on different surfaces of the towed vehicle 303. For example, the targets 388 provided on each surface of the towed vehicle 303 may have a unique pattern to facilitate differentiation between the surfaces. Each target 388 may, for example, comprise a reflective element. The at least one target 388 may each comprise a reflective lens or a reflective material suitable for returning light in the direction of transmission. A plurality of targets 388 may be arranged on a substrate or backing. The targets 388 may have a defined spatial separation and/or angular separation to facilitate identification. The targets 388 could optionally be coloured, for example comprising a coloured reflective lens.

In the arrangement illustrated in FIG. 29, one (1) target 388 is provided on a rear surface of the towed vehicle 303. The target 388 comprises a reflective element configured to reflect light emitted from a light source provided in the parking beacon 305. The light source could be configured to transmit an encoded light pattern to facilitate identification of the target 388. The encoded light pattern may, for example, comprise a predetermined pattern or signal which is identifiable in the light reflected by the target 388. The image captured by the beacon camera 368 may be analysed to identify an image element (or plurality of image elements) which changes in accordance with the predetermined encoded pattern. The encoded pattern may comprise scan times associated with a particular optical guide means 330, and the image analysis may be configured to identify this pattern. A plurality of targets 388 may be provided in a known configuration (for example in a known geometric configuration) to facilitate filtering of the image data, for example to reduce or remove image noise caused by light reflecting off other surfaces.

The parking beacon 305 could be provided with a dedicated light source for transmitting light for reflection off of the target(s) 388. In the present embodiment, however, it is envisaged that the first projection system 328 is configured to scan a region where the towed vehicle 303 is likely or expected to be situated. As described herein, the first projection system 328 may comprise a light source in the form of a laser. The first projection system 328 may, for example, be configured to rotate the optical guide means 330 about the transverse axis Y1 so as to scan the beam of light in a vertical plane, as illustrated in FIG. 29. The beam of light emitted from the first projection system 328 may be scanned across as a vertical fan or scanned in a raster pattern to locate the target 388. At least some of the light emitted from the first projection system 328 which is incident on the target 388 is reflected back towards the beacon 305. The reflected light is detected by processing the image data generated by the beacon camera 368, thereby enabling identification of the target 388. Using appropriate image processing techniques, the location and orientation of the target 388 may be determined. Once the target 388 is located, the optical guide means 330 may be controlled to scan the light over a reduced or limited area in the region of a last known position. Alternatively, or in addition, the approximate location of the target 388 may be determined using the beacon camera 368. The approximate location may be used to optimise the scanning performed by the optical guide means 330. By identifying the target 388, the image data may be processed to identify the location of the towed vehicle 303. The orientation of the towed vehicle 303 may be determined by tracking its movement.

A plurality of the targets 388 may be arranged in a predefined pattern, for example having a predefined angular separation between the targets 388 and/or a predefined spatial separation between the targets 388. The predefined pattern may be a geometric pattern. When the targets 388 are scanned, for example by scanning the laser emitted by the first projection system 328, the returned pulses will have a time separation which is dependent on the angular and/or spatial separation of the targets 388. The angular separation of the targets 388 and the distance to the targets 388 can be determined with reference to the angular scan speed of the optical guide means 330. The polar position of the towed vehicle 303 and the distance from the beacon 305 to the towed vehicle 303 may thereby be determined. Thus, the first projection system 328 and the beacon camera 368 may be used to determine the relative location and orientation of the towed vehicle 303.

A first set comprising one or more of the targets 388 may be provided on a first surface of the towed vehicle 303, for example provided on the rear of the towed vehicle 303. A second set comprising one or more of the targets 388 may be provided on a second surface of the towed vehicle 303, for example on a side of the towed vehicle 303. The second set of targets 388 may be oriented orthogonally relative to the first set of targets 388. The provision of first and second sets of the targets 388 may help to reduce errors in determining the orientation of the towed vehicle 303. Alternatively, any such orientation errors may be identified by analysing changes in their relative position in dependence on the trajectory of the towed vehicle 303 when it moves. A correction may be applied to correct any identified orientation errors to determine the orientation of the towed vehicle 303.

A target 388 may optionally be applied to the towed vehicle 303 to identify particular features, for example to identify the door 384; and/or the electrical connector 385.

The concept of applying at least one target 388 to the towed vehicle 303 may be employed in the other embodiments described herein. For example, at least one target 388 may be provided on the remote vehicle 250 to facilitate identification thereof. Alternatively, or in addition, the beacon 305 may be provided with at least one target 388 to facilitate identification thereof. Rather than apply a separate target 388, the concept may make use of existing reflectors provided on the towing vehicle 302, the towed vehicle 303 or the remote vehicle 305. For example, the techniques described herein may seek to identify light reflected by a reflector associated with a lamp or light provided on the vehicle. The technique, may for example, seeks to identify light reflected from one or more of the following set: a reversing light, a tail light, a side light, a turning indicator and a head lamp. The different colour of the light reflected by the different reflectors may be used to refine the location and/or orientation of the vehicle.

It will be appreciated that various modifications may be made to the embodiment(s) described herein without departing from the scope of the appended claims.

The parking assist controller 104 has been described with reference to identifying the parking location indicator 126 by analysing the image data from on-board camera(s). It will be understood that other techniques may be used to determine the location of the parking beacon 105. For example, signal triangulation could be used to determine the location of the parking beacon 105. The towing vehicle 102 and/or the towing vehicle 103 may each comprise one or more transceivers for communicating with the parking beacon 105. By measuring the time-of-flight for communications with the parking beacon 105, the parking assist controller 104 may determine the location of the parking beacon 105. A user may use one or more of said parking beacon 105 to mark a target position. The parking beacon 105 may operatively control the optical system described herein to provide a visible representation of the target position.

The parking beacon 105 may be configured to project the target path R onto the ground. For example, the parking assist controller 104 may transmit the target path R to the parking beacon 105. The parking beacon 105 may project the target path R onto the ground to enable the user to visualise the proposed route and optionally also to confirm the route. The light source 29 and the mirror 30 may be controlled to display the target path R. By visually projecting the target path R onto the ground, the user may consider aspects like ground condition and/or inclination that may be less evident when reviewing a video image output to a screen.

The systems and methods described herein may be used in conjunction with a plurality of the parking beacons. For example, the parking beacons may be arranged to form a substantially continuous chain alongside the target route.

1. A projection system for projecting an indicator to provide a visible representation of at least a portion of a target route, the projection system comprising:
a light source operable to emit light;
image forming means for forming the indicator; and
a processor for controlling the image forming means, wherein the processor is configured to:
determine a target route; and
based on the determined target route, control the image forming means to control the light emitted from the light source to form the indicator.

2. A projection system as claimed in claim 1, wherein the indicator comprises either or both of a direction marker and a path line for representing the target route.

3. A projection system as claimed in claim 1, wherein the image forming means is operable to project the indicator onto the ground.

4. A projection system as claimed in claim 1, wherein the image forming means comprises optical guide means for defining a light path for light emitted from the light source, and wherein the optical guide means is movable to control the direction of the light path.

5. A projection system as claimed in claim 1, wherein the image forming means comprises a light engine, the processor being further configured to control the light engine to form an image corresponding to the indicator.

6. A projection system as claimed claim 1, further comprising a self-levelling assembly for supporting the light source and the image forming means.

7. A projection system as claimed in claim 1, wherein each light source comprises a light emitting diode or a laser diode.

8. A projection system as claimed in claim 1, wherein the indicator is a target route indicator and the processor is further configured to:
generate the target route indicator for projection onto a section of ground to provide a visual representation of the determined target route;
receive image data from one or more image sensors, the image data comprising an image of a section of ground onto which the target route indicator is projected;
process the image data to identify an incident route indicator generated by the projection of the route indicator;
identify distortions in the incident route indicator caused by projecting the route indicator onto the section of ground; and
identify one or more terrain features in said section of ground based on the identified distortions.

9. A parking beacon comprising a projection system as claimed in claim 1.

10. A parking beacon as claimed in claim 9, the parking beacon further comprising:
an imaging system for capturing an image of the indicator projected onto a surface; and
an imaging processor for comparing the captured image with a reference image of the projected indicator, the imaging processor being configured to determine a characteristic of the surface based on said comparison.

11. A parking beacon as claimed in claim 10, wherein the surface is a section of ground and wherein the characteristic determined by the imaging processor comprises a gradient or contour map of the section of ground.

12. A vehicle comprising a projection system as claimed in claim 1.

13. A vehicle as claimed in claim 12, the vehicle comprising:
an imaging system for capturing an image of the indicator projected onto a surface; and
an imaging processor for comparing the captured image with a reference image of the projected indicator, the imaging processor being configured to determine a characteristic of the surface based on said comparison.

14. A vehicle as claimed in claim 13, wherein the surface is a section of ground and the characteristic determined by the imaging processor comprises a gradient or contour map of the section of ground.

15. A vehicle as claimed in claim 13, further comprising a guidance module for determining a target route for the vehicle, the guidance module being configured to alter the vehicle trajectory based on the determined characteristic of the surface.

16. A parking assist controller for parking a vehicle, the parking assist controller being configured to:
receive image data from one or more image sensors;
analyse the image data to identify an indicator projected by a projection system as claimed in claim 1; and
determine a target route for the vehicle based on the identified indicator.

17. A parking assist controller as claimed in claim 16, wherein the parking assist controller is further configured to generate a parking assist signal based on the determined target route.

18. A parking assist controller as claimed in claim 16, wherein the projection system comprises a part of one of either a parking beacon or a vehicle, and wherein the parking assist controller comprises a part of the other one of either the parking beacon or the vehicle.

19. A route analysis system for a vehicle, the route analysis system comprising a processor configured to:
determine a target route for the vehicle;
generate a target route indicator for projection onto a section of ground to provide a visual representation of the determined target route;
receive image data from one or more image sensors, the image data comprising an image of a section of ground onto which the target route indicator is projected;
process the image data to identify an incident route indicator generated by the projection of the route indicator;
identify distortions in the incident route indicator caused by projecting the route indicator onto the section of ground; and
identify one or more terrain features in said section of ground based on the identified distortions.

20. A terrain feature analysis system for use with a vehicle, the terrain feature analysis system comprising a processor configured to:
receive image data from one or more image sensors, the image data comprising an image of a section of ground onto which a predetermined reference pattern is projected;
process the image data to identify an incident pattern generated by the projection of the predetermined reference pattern onto the section of ground;
identify distortions in the incident pattern caused by projecting the predetermined reference pattern onto the section of ground; and
identify one or more terrain features in said section of ground based on the identified distortions.
